(19) United States
(12) Patent Application Publication
(10) Pub. No.: US 2026/0219594 A1
(43) Pub. Date: Jul. 30, 2026

(54) TONER FOR DEVELOPING ELECTROSTATIC CHARGE IMAGE

(71) Applicant: KAO CORPORATION, Tokyo (JP)

(72) Inventors: Yuji MARUNO, Wakayama-shi (JP); Kanta NIIYA, Wakayama-shi (JP); Nobuaki OKAUCHI, Wakayama-shi (JP); George HIRAI, Wakayama-shi (JP); Shoichi MURATA, Wakayama-shi (JP)

(73) Assignee: KAO CORPORATION, Tokyo (JP)

(21) Appl. No.: 19/137,443

(22) PCT Filed: Dec. 12, 2023
(86) PCT No.: PCT/JP2023/044456

§ 371 Date: Jun. 10, 2025

(30) Foreign Application Priority Data
Dec. 19, 2022 (JP) 2022-202389

(51) Int. Cl. G03G 9/087; G03G 9/08; G03G 9/09

(52) U.S. Cl. CPC G03G 9/08755; G03G 9/0804; G03G 9/0817; G03G 9/091

(57) ABSTRACT

A toner for electrostatic image development. The toner contains a binder resin and a colorant. The binder resin contains an amorphous polyester resin A having an ester group concentration of 5.0 mmol/g or more and 12.0 mmol/g or less, and the colorant is an organic yellow pigment having an NH group content of 4.0 mmol/g or more and 15.0 mmol/g or less. The NH group content is a value obtained by dividing a total number of —NH— and —NH₂ contained in one molecule by a molecular weight.

### TECHNICAL FIELD

The present invention relates to a toner for electrostatic image development used for developing a latent image formed in an electrophotographic method, an electrostatic recording method, an electrostatic printing method, or the like.

### BACKGROUND ART

In the field of electrophotography, development of electrophotographic toners corresponding to high image quality and high speed is required with development of the electrophotographic system. A so-called chemical toner is produced by an aggregating and coalescing method (emulsion aggregation method, aggregation integration method), in which fine resin particles and the like are aggregated and coalesced in an aqueous medium to produce a toner, the method being used as a method for producing a toner having a narrow particle size distribution, a small particle size, and fusing property capable of coping with high speed in order to cope with high image quality.

Patent Literature 1 (JP 2020-154154 A) discloses, for the purpose of providing a method for producing a toner with high yield wherein a decrease in chargeability after high-temperature and high-humidity storage is suppressed, a method for producing a toner including a step of aggregating and coalescing resin particles and colorant particles, wherein the resin particles contain a crystalline polyester resin C, and the colorant particles contain a colorant having 3 or more aromatic rings in one molecule and having a molecular weight of 600 or more and 1500 or less, and an addition polymer of raw material monomers containing an addition polymerizable monomer having an aromatic group.

Patent Literature 2 (WO 2014/112488 A) discloses, for the purpose of providing a method for producing a toner having a narrow particle size distribution and excellent dot reproducibility and charge stability, a method for producing a toner for electrostatic image development, the method including step (1): mixing a polyester resin and a basic aqueous solution to produce a resin neutralized product, step (2): adding an aqueous medium to the resin neutralized product produced in step (1) and emulsifying the mixture to produce a resin particle dispersion, step (3): aggregating resin particles in the resin particle dispersion produced in step (2) to produce aggregated particles, and step (4): coalescing the aggregated particles produced in step (3) to produce toner particles, wherein the polyester resin has an ester group concentration of 6.3 mmol/g or more and 12 mmol/g or less, the basic aqueous solution has a pH of 8.5 or more and 13.5 or less at 25° C., and the content of an organic solvent in the resin neutralized product is 10 mass % or less.

### SUMMARY OF INVENTION

The present invention relates to [1] described below.

[1]A toner for electrostatic image development, containing a binder resin and a colorant, wherein
the binder resin contains an amorphous polyester resin A having an ester group concentration of 5.0 mmol/g or more and 12.0 mmol/g or less, and
the colorant is an organic yellow pigment having an NH group content of 4.0 mmol/g or more and 15.0 mmol/g or less wherein the NH group content is a value obtained by dividing a total number of —NH— and —NH₂ contained in one molecule by a molecular weight.

### DESCRIPTION OF EMBODIMENTS

As a result of studies by the present inventors, it has been found that when the toner produced by the toner production method described in Patent Literature 1 or 2 contains a relatively highly hydrophilic organic yellow pigment as a colorant, the chargeability of the toner and the image density of a printed matter are required to be improved.

The present invention relates to a toner for electrostatic image development having excellent chargeability and capable of providing a printed matter having a high image density.

The present inventors have found that a toner for electrostatic image development containing a binder resin containing an amorphous polyester resin having an ester group concentration in a specific range and an organic yellow pigment having an NH group content in a specific range has excellent chargeability, and a printed matter having a higher image density can be produced by using the toner.

The present invention provides a toner for electrostatic image development having excellent chargeability and capable of providing a printed matter having a high image density.

### [Toner for Electrostatic Image Development]

The toner for electrostatic image development (hereinafter, also simply referred to as “toner”) of the present invention contains at least a binder resin and an organic yellow pigment.

The binder resin contains an amorphous polyester resin A (hereinafter, also simply referred to as “resin A”) having an ester group concentration of 5.0 mmol/g or more and 12.0 mmol/g or less. The colorant is an organic yellow pigment having an NH group content of 4.0 mmol/g or more and 15.0 mmol/g or less wherein the NH group content is a value obtained by dividing the total number of —NH— and —NH₂ contained in one molecule by a molecular weight.

Because of the above-described characteristics, the toner of the present invention has excellent chargeability and can provide a printed matter having a high image density.

Toner particles containing at least a binder resin and an organic yellow pigment (hereinafter, also simply to as “toner particles”) can be used as they are as the toner of the present invention, but it is preferable to use, as the toner, toner particles to which a fluidizer or the like is added as an external additive on the surfaces of the toner particles.

The reason why the toner of the present invention has excellent chargeability and can provide a printed matter having a high image density is not clear, but the reason is considered as follows.

When an organic yellow pigment having a high NH group content and relatively high hydrophilicity is used in the toner, the dispersibility of the pigment in toner particles is likely to be insufficient, and the pigment is exposed on the surfaces of the toner particles during production of the toner particles, which is considered to adversely affect chargeability and the image density of a printed matter. It is considered that, in the present invention, since the amorphous polyester resin A having a high ester group concentration is used for the binder resin, the affinity between the polyester resin and the pigment is improved because of hydrogen bonding between the ester group and the amino group of the pigment, and thus the pigment is easily and finely dispersed in the polyester resin, and not only the exposure of the pigment on the surfaces of the toner particles is suppressed, but also the pigment can be homogeneously incorporated into the toner particles, and as a result, the chargeability of the toner is improved, and a printed matter having a high image density can be produced.

Definitions and the like of various terms in the present specification are described below.

In the specification, a carboxylic acid component of a polyester-based resin includes not only its compound, but also an anhydride that is decomposed during the reaction to generate a carboxylic acid and an alkyl ester of each carboxylic acid (having 1 or more and 3 or less carbons in the alkyl group).

Whether a resin is crystalline or amorphous is determined by using the crystallinity index. The crystallinity index is defined by the ratio of the softening point of the resin to the maximum endothermic peak temperature thereof (softening point (° C.)/maximum endothermic peak temperature (° C.)) in the measurement method described below in Examples. A crystalline resin is a resin having a crystallinity index of 0.6 or more and 1.4 or less. An amorphous resin is a resin exhibiting no endothermic peak or having a crystallinity index of less than 0.6 or more than 1.4 when an endothermic peak is observed. The crystallinity index can be appropriately adjusted by the types of raw material monomers and the proportions thereof, and production conditions such as reaction temperature, reaction time, and cooling rate.

“(Meth)acrylic acid” means at least one selected from acrylic acid and methacrylic acid.

“(Meth)acrylate” means at least one selected from acrylate and methacrylate.

“Styrene-based compound” means unsubstituted or substituted styrene.

### [Toner Particles]

In the present invention, the toner particles contain at least a binder resin and a colorant.

### <Binder Resin>

The binder resin contains an amorphous polyester resin A (hereinafter, also simply referred to as “resin A”) having an ester group concentration of 5.0 mmol/g or more and 12.0 mmol/g or less.

### (Amorphous Polyester Resin A)

The amorphous polyester resin A is a polycondensate of an alcohol component (a) and a carboxylic acid component (b).

The alcohol component (a) preferably contains an aliphatic diol, more preferably contains a linear or branched aliphatic diol (a1) having 5 or 6 carbons, and the alcohol component (a) may further contain a linear or branched aliphatic diol (a2) having 2 or more and 4 or less carbons.

Examples of the linear or branched aliphatic diol (a1) having 5 or 6 carbons include 1,5-pentanediol, 1,2-pentanediol, 1,3-pentanediol, 1,4-pentanediol, 2,3-pentanediol, 2,4-pentanediol, neopentyl glycol, 2-ethyl-2-methyl-1,3-propanediol, 2-methyl-1,4-butanediol, 2-ethyl-1,4-butanediol, 2,2-dimethyl-1,4-butanediol, 2,3-dimethyl-1,4-butanediol, 2-methyl-1,5-pentanediol, 3-methyl-1,5-pentanediol, and 1,6-hexanediol. The aliphatic diol (a1) is preferably neopentyl glycol, 2-ethyl-2-methyl-1,3-propanediol, 2,2-dimethyl-1,4-butanediol, and 3-methyl-1,5-pentanediol, more preferably neopentyl glycol and 3-methyl-1,5-pentanediol, and more preferably neopentyl glycol.

One type or two or more types of these aliphatic diols (a1) may be used.

Examples of the linear or branched aliphatic diol (a2) having 2 or more and 4 or less carbons include ethylene glycol, 1,2-propanediol, 1,3-propanediol, 1,2-butanediol, 1,3-butanediol, 1,4-butanediol, 2,3-butanediol, and 2-methyl-1,3-propanediol. Ethylene glycol is preferable.

One type or two or more types of these aliphatic diols (a2) may be used.

The content of the aliphatic diol (a1) in the alcohol component (a) is preferably 30 mol % or more, more preferably 40 mol % or more, still more preferably 50 mol % or more, and is 100 mol % or less, from the viewpoint of achieving a desired ester group concentration.

The content of the aliphatic diol (a2) in the alcohol component (a) is preferably 0 mol % or more, and is preferably 60 mol % or less, more preferably 50 mol % or less, from the viewpoint of achieving a desired ester group concentration.

The content of the aliphatic diol in the alcohol component (a) is preferably 30 mol % or more, more preferably 60 mol % or more, still more preferably 80 mol % or more, still more preferably 90 mol % or more, and is 100 mol % or less, from the viewpoint of achieving a desired ester group concentration.

Examples of the alcohol component (a) other than the aliphatic diols (a1) and (a2) include an aromatic diol alkylene oxide adduct and a trivalent or higher-valent polyhydric alcohol.

Examples of the aromatic diol alkylene oxide adduct include a bisphenol A alkylene oxide adduct represented by Formula (I):

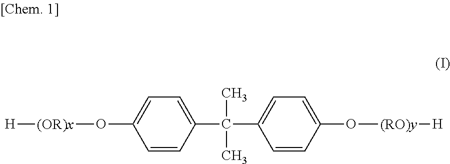

(wherein OR and RO are an oxyalkylene group, R is each independently an ethylene or propylene group, x and y represent the number of moles added of the alkylene oxide and are each a positive number, and the sum of x and y is 1 or more, preferably 1.5 or more, and 16 or less, preferably 8 or less, more preferably 4 or less).

Examples of the bisphenol A alkylene oxide adduct represented by Formula (I) include a 2,2-bis(4-hydroxyphenyl)propane propylene oxide adduct and a 2,2-bis(4-hydroxyphenyl)propane ethylene oxide adduct.

Examples of the trivalent or higher-valent polyhydric alcohol include glycerin, pentaerythritol, trimethylolpropane, and sorbitol.

One type or two or more types of these may be used.

Examples of the carboxylic acid component (b) include aromatic dicarboxylic acids, aliphatic dicarboxylic acids, alicyclic dicarboxylic acids, and trivalent or higher-valent carboxylic acids.

Among these, the carboxylic acid component (b) preferably contains an aromatic dicarboxylic acid from the viewpoint of achieving a desired ester group concentration.

From the above viewpoint, the aromatic dicarboxylic acid is more preferably at least one selected from terephthalic acid and isophthalic acid, and still more preferably contains terephthalic acid and isophthalic acid.

The content of the aromatic dicarboxylic acid in the carboxylic acid component (b) is preferably 60 mol % or more, more preferably 70 mol % or more, still more preferably 80 mol % or more, and preferably 100 mol % or less, more preferably 100 mol %, from the viewpoint of obtaining the amorphous polyester resin A having a desired ester group concentration.

Examples of the aliphatic dicarboxylic acid include aliphatic dicarboxylic acids such as oxalic acid, malonic acid, maleic acid, fumaric acid, citraconic acid, itaconic acid, glutaconic acid, adipic acid, succinic acid, and succinic acid optionally substituted with an aliphatic hydrocarbon group having 1 or more and 20 or less carbons.

Examples of the succinic acid substituted with an aliphatic hydrocarbon group having 1 or more and 20 or less carbons include octylsuccinic acid and dodecenylsuccinic acid (tetrapropenylsuccinic acid).

Examples of the alicyclic dicarboxylic acid include cyclohexanedicarboxylic acid.

Examples of the trivalent or higher-valent carboxylic acid include 1,2,4-benzenetricarboxylic acid (trimellitic acid), 2,5,7-naphthalenetricarboxylic acid, and pyromellitic acid. Among these, trimellitic acid and an anhydride thereof are preferable.

The alcohol component (a) may appropriately contain a monohydric alcohol, and the carboxylic acid component (b) may appropriately contain a monovalent carboxylic acid.

The equivalent ratio of carboxy groups of the carboxylic acid component to hydroxyl groups of the alcohol component (a) [COOH group/OH group] is preferably 0.7 or more and more preferably 0.8 or more, and is preferably 1.3 or less and more preferably 1.2 or less.

The resin A has an ester group concentration of 5.0 mmol/g or more and 12.0 mmol/g or less, preferably 5.5 mmol/g or more, more preferably 6.0 mmol/g or more, and preferably 10.0 mmol/g or less, from the viewpoint of the chargeability of the toner and the image density of the printed matter. The ester group concentration of the resin A is calculated from the following formula.

$$[ Math . 1 ]$$

$$[ Ester group concentration ( mmol / g ) ] = \frac{[ A ( mol ) ]}{[ B ( g ) - A ( mol ) \times 18 ]} \times {10}^{3}$$

[In the formula, Ais the total ester bond amount (mol) produced when all the raw material monomers of the amorphous polyester resin A are reacted, and B is the total mass (g) of the raw material monomers constituting the amorphous polyester resin A. In the formula, the unit of each numerical value is shown in parentheses.]

When two or more resins are mixed and used as the amorphous polyester resin A, the weighted average of the ester group concentrations of the respective amorphous polyester resins A is taken as the ester group concentration of the amorphous polyester resin A.

### Method for Producing Amorphous Polyester Resin A

The resin A can be produced, for example, through polycondensation of the raw material monomers containing the alcohol component (a) and the carboxylic acid component (b).

The polycondensation of the alcohol component (a) and the carboxylic acid component (b) can be performed, for example, at a temperature of about 120° C. or higher and 250° C. or lower in an inert gas atmosphere in the presence of an esterification catalyst, an esterification cocatalyst, a polymerization inhibitor, or the like as necessary.

Examples of the esterification catalyst include tin compounds such as dibutyltin oxide and tin(II) di(2-ethylhexanoate), and titanium compounds such as titanium diisopropoxybis(triethanolaminate). Examples of the esterification cocatalyst that can be used together with the esterification catalyst include gallic acid.

The amount of the esterification catalyst to be used is preferably 0.01 parts by mass or more and 10 parts by mass or less relative to 100 parts by mass of the total amount of the alcohol component (a) and the carboxylic acid component (b), which are raw material monomers of the resin A.

The amount of the esterification cocatalyst to be used is preferably 0.001 parts by mass or more and 1 part by mass or less relative to 100 parts by mass of the total amount of the alcohol component (a) and the carboxylic acid component (b).

Examples of the polymerization inhibitor include radical polymerization inhibitors such as 4-tert-butylcatechol.

When a polymerization inhibitor is used, the amount of the polymerization inhibitor to be used is preferably 0.001 parts by mass or more and 1 part by mass or less relative to 100 parts by mass of the total amount of the alcohol component (a) and the carboxylic acid component (b).

### <<Physical Properties of Amorphous Polyester Resin A>>

The softening point of the resin A is preferably 70° C. or higher, more preferably 80° C. or higher, and still more preferably 90° C. or higher from the viewpoint of heat-resistant storage stability, and is preferably 130° C. or lower, more preferably 120° C. or lower, still more preferably 110° C. or lower from the viewpoint of low-temperature fusing property.

The glass transition temperature of the resin A is preferably 30° C. or higher, more preferably 35° C. or higher, and still more preferably 40° C. or higher from the viewpoint of heat-resistant storage stability, and is preferably 80° C. or lower, more preferably 70° C. or lower, still more preferably 65° C. or lower from the viewpoint of low-temperature fusing property.

The acid value of the resin A is preferably 5 mgKOH/g or more, more preferably 8 mgKOH/g or more, and still more preferably 10 mgKOH/g or more, and is preferably 40 mgKOH/g or less, more preferably 30 mgKOH/g or less, and still more preferably 25 mgKOH/g or less.

The ester group concentration, softening point, glass transition temperature, and acid value of the resin A can be appropriately adjusted depending on the types and the amounts of the raw material monomers to be used, and the production conditions such as the reaction temperature, the reaction time, and the cooling rate. The softening point, glass transition temperature, and acid value of the resin A are determined by the methods described in Examples.

When two or more types of resins A are used in combination, it is preferable that the softening point, glass transition temperature, and acid value of the mixture of the resins respectively fall within the above ranges.

### (Amorphous Resin B)

The binder resin may contain an amorphous resin B (hereinafter, also simply referred to as “resin B”) besides the resin A. Examples of the resin B include amorphous polyester resins having an ester group concentration of less than 5.0 mmol/g and styrene acrylic resins.

### (Crystalline Polyester Resin C)

From the viewpoint of the chargeability of the toner and the image density of the printed matter, the binder resin preferably contains a crystalline polyester resin C (hereinafter, also simply referred to as “resin C”).

The crystalline polyester resin C is a polycondensate of an alcohol component and a carboxylic acid component.

The alcohol component is preferably an α,ω-aliphatic diol.

The carbon number of the α,ω-aliphatic diol is preferably 2 or more, and is preferably 16 or less, more preferably 14 or less, and still more preferably 12 or less.

Examples of the α,ω-aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, and 1,14-tetradecanediol. Among these, ethylene glycol, 1,6-hexanediol, 1,10-decanediol, and 1,12-dodecanediol are preferable, ethylene glycol and 1,10-decanediol are more preferable, and ethylene glycol is still more preferable.

The amount of the α,ω-aliphatic diol in the alcohol component is preferably 80 mol % or more, more preferably 85 mol % or more, still more preferably 90 mol % or more, still more preferably 95 mol % or more, and 100 mol % or less, preferably 100 mol %.

The alcohol component may contain an additional alcohol component different from the α,ω-aliphatic diol. Examples of the additional alcohol component include aliphatic diols other than the α,ω-aliphatic diol, such as 1,2-propanediol and neopentyl glycol; aromatic diols such as bisphenol A alkylene oxide adducts; and trivalent or higher-valent alcohols such as glycerin, pentaerythritol, and trimethylolpropane. One type or two or more types of these alcohol components may be used.

The carboxylic acid component is preferably an aliphatic dicarboxylic acid, and is more preferably a linear aliphatic dicarboxylic acid.

The number of carbons in the aliphatic dicarboxylic acid is preferably 4 or more, more preferably 8 or more, still more preferably 10 or more, and is preferably 14 or less, more preferably 12 or less.

Examples of the aliphatic dicarboxylic acid include fumaric acid, sebacic acid, dodecanedioic acid, and tetradecanedioic acid. Among these, sebacic acid and dodecanedioic acid are preferable, and sebacic acid is more preferable. One type or two or more types of these carboxylic acid components may be used.

The amount of the aliphatic dicarboxylic acid in the carboxylic acid component is preferably 80 mol % or more, more preferably 85 mol % or more, still more preferably 90 mol % or more, still more preferably 95 mol % or more, and is 100 mol % or less, still more preferably 100 mol %.

The carboxylic acid component preferably contains a monocarboxylic acid having 6 or more and 24 or less carbons from the viewpoint of the chargeability of the toner and the image density of the printed matter. From the same viewpoint, the number of carbons in the monocarboxylic acid is 6 or more, preferably 8 or more, more preferably 12 or more, still more preferably 14 or more, and still more preferably 16 or more, and is 24 or less, preferably 22 or less, and more preferably 20 or less.

Examples of the monocarboxylic acid having 6 or more and 24 or less carbons include caprylic acid, pelargonic acid, lauric acid, myristic acid, palmitic acid, stearic acid, arachidic acid, behenic acid, and lignoceric acid. Among these, caprylic acid, lauric acid, stearic acid, and behenic acid are preferable, stearic acid and behenic acid are more preferable, and stearic acid is still more preferable from the viewpoint of the chargeability of the toner and the image density of the printed matter.

The amount of the monocarboxylic acid having 6 or more and 24 or less carbons in the carboxylic acid component is preferably 1 mol % or more, more preferably 5 mol % or more, still more preferably 7 mol % or more, and is preferably 35 mol % or less, more preferably 30 mol % or less, still more preferably 20 mol % or less, still more preferably 15 mol % or less.

The carboxylic acid component may contain an additional carboxylic acid component different from the aliphatic dicarboxylic acid. Examples of the additional carboxylic acid component include aromatic dicarboxylic acids such as terephthalic acid and isophthalic acid; and trivalent or higher polyvalent carboxylic acids. One type or two or more types of these carboxylic acid components may be used.

The equivalent ratio of the carboxy groups of the carboxylic acid component to the hydroxyl groups of the alcohol component [COOH group/OH group] is preferably 0.7 or more and more preferably 0.8 or more, and is preferably 1.3 or less and more preferably 1.2 or less.

Examples of the method for producing the resin C include the same method as the method for producing the resin A as a polyester resin.

### <<Physical Properties of Crystalline Polyester Resin C>>

The softening point of the resin C is preferably 60° C. or higher, more preferably 70° C. or higher, and still more preferably 75° C. or higher from the viewpoint of the storage stability of the toner, and is preferably 150° C. or lower, more preferably 120° C. or lower, and still more preferably 100° C. or lower from the viewpoint of further improving the low-temperature fusing property.

The melting point of the resin C is preferably 50° C. or higher, more preferably 60° C. or higher, and still more preferably 70° C. or higher from the viewpoint of the storage stability of the toner, and is preferably 100° C. or lower, more preferably 90° C. or lower, and still more preferably 80° C. or lower from the viewpoint of further improving the low-temperature fusing property.

The acid value of the resin C is preferably 5 mgKOH/g or more, and is preferably 35 mgKOH/g or less, more preferably 25 mgKOH/g or less, still more preferably 20 mgKOH/g or less.

The softening point, melting point, and acid value of the resin C can be appropriately adjusted depending on the types and amounts of the raw material monomers to be used, and the production conditions such as the reaction temperature, the reaction time, and the cooling rate. The softening point, melting point, and acid value of the resin C are determined by the methods described below in Examples. When two or more resins C are used in combination, it is preferable that the softening point, melting point, and acid value of the mixture of the resins respectively fall within the above ranges.

In the present invention, the binder resin means the resin A, the resin B, and the resin C.

The content of the binder resin in the toner particles is preferably 60 mass % or more, more preferably 70 mass % or more, still more preferably 75 mass % or more, and is preferably less than 100 mass %, more preferably 95 mass % or less, from the viewpoint of the chargeability of the toner and the image density of the printed matter.

The content of the resin A in the binder resin is preferably 50 mass % or more, more preferably 70 mass % or more, and is preferably 97 mass % or less, more preferably 95 mass % or less, still more preferably 90 mass % or less, from the viewpoint of the image density of the printed matter.

The content of the resin C in the binder resin is preferably 3 mass % or more, more preferably 5 mass % or more, still more preferably 10 mass % or more, and is preferably 50 mass % or less, more preferably 30 mass % or less, from the viewpoint of the image density of the printed matter.

The total content of the resin A and the resin C in the binder resin is preferably 70 mass % or more, more preferably 80 mass % or more, still more preferably 90 mass % or more, and is preferably 100 mass % or less, more preferably 100 mass %, from the viewpoint of the chargeability of the toner and the image density of the printed matter.

The mass ratio of the resin C to the resin A in the toner particles [resin C/resin A] is preferably 0.03 or more, more preferably 0.05 or more, still more preferably 0.07 or more, and is preferably 0.50 or less, more preferably 0.40 or less, still more preferably 0.30 or less, from the viewpoint of the low-temperature fusing property.

### <Colorant>

In the present invention, the toner particles contain an organic yellow pigment as a colorant.

Here, when the value obtained by dividing the total number of —NH— and —NH₂ contained in one molecule of the organic yellow pigment by the molecular weight of the pigment is defined as an NH group content, the NH group content of the pigment is 4.0 mmol/g or more, preferably 5.0 mmol/g or more, more preferably 7.0 mmol/g or more, and is 15.0 mmol/g or less, preferably 12.0 mmol/g or less.

The colorant to be used in the present invention is preferably at least one selected from a benzimidazolone pigment, an isoindoline-based pigment, and a condensed disazo-based pigment, and more preferably at least one selected from a benzimidazolone pigment and an isoindoline-based pigment, from the viewpoint of achieving a desired NH group content.

Examples of the benzimidazolone pigment include C.I. Pigment Yellow 180 (total number of —NH— and —NH₂ in one molecule=6, molecular weight=733, NH group content=8.2 mmol/g).

Examples of the isoindoline-based pigment include C.I. Pigment Yellow 185 (total number of —NH— and —NH₂ in one molecule=4, molecular weight=337, NH group content=11.9 mmol/g).

Examples of the condensed disazo-based pigment include C.I. Pigment Yellow 93 (total number of —NH— and —NH₂ in one molecule=4, molecular weight=937, NH group content=4.3 mmol/g) and C.I. Pigment Yellow 95 (total number of —NH— and —NH₂ in one molecule=4, molecular weight=917, NH group content=4.4 mmol/g).

The pigment to be used in the present invention is preferably at least one selected from C.I. Pigment Yellow 180 and C.I. Pigment Yellow 185 from the viewpoint of the chargeability of the toner and the image density of the printed matter.

The content of the colorant in the toner particles is preferably 1 mass % or more, more preferably 2 mass % or more, and is preferably 20 mass % or less, more preferably 15 mass % or less, still more preferably 10 mass % or less.

The amount of the colorant is preferably 1 part by mass or more, more preferably 2 parts by mass or more, still more preferably 3 parts by mass or more, and is preferably 20 parts by mass or less, more preferably 15 parts by mass or less, still more preferably 10 parts by mass or less relative to 100 parts by mass of the total of the resin A and the resin C, from the viewpoint of improving the dispersibility in the toner particles.

### <Releasing Agent>

The toner particles preferably contain a releasing agent.

Examples of the releasing agent include polypropylene wax, polyethylene wax, ethylene-propylene copolymer wax; hydrocarbon-based waxes such as microcrystalline wax, paraffin wax, and Fischer-Tropsch wax, or oxides thereof; ester-based waxes such as carnauba wax, montan wax, or deacidified wax thereof, and fatty acid ester wax; fatty acid amides, fatty acids, higher alcohols, and fatty acid metal salts. One type or two or more types of these may be used.

The melting point of the releasing agent is preferably 60° C. or higher and more preferably 70° C. or higher, and is preferably 160° C. or lower, more preferably 140° C. or lower, still more preferably 120° C. or lower, and still more preferably 100° C. or lower.

The content of the releasing agent in the toner particles is preferably 0.1 mass % or more, more preferably 1 mass % or more, and still more preferably 3 mass % or more, and is preferably 25 mass % or less, more preferably 21 mass % or less, and still more preferably 17 mass % or less.

In addition, the toner particles may contain an additive such as a charge control agent, a magnetic powder, a fluidity improver, a conductivity modifier, a reinforcing filler such as a fibrous substance, an antioxidant, an anti-aging agent, or a cleaning property improver.

### <Physical Properties of Toner Particles>

The volume median particle size D₅₀ of the toner particles is preferably 2 μm or more, more preferably 3 μm or more, and still more preferably 4 μm or more, and is preferably 10 μm or less, more preferably 8 μm or less, and still more preferably 7 μm or less, from the viewpoint of obtaining a printed coating film having a good image quality and from the viewpoint of further improving the cleaning property of the toner.

The circularity of the toner particles is preferably 0.955 or more, and more preferably 0.960 or more from the viewpoint of obtaining a printed coating film (image) having a good image quality, and is preferably 0.990 or less, more preferably 0.985 or less, and still more preferably 0.980 or less from the viewpoint of the cleaning property.

The CV value of the toner particles is preferably 10% or more, more preferably 12% or more, and still more preferably 14% or more from the viewpoint of improving the productivity of the toner, and is preferably 50% or less, more preferably 45% or less, and still more preferably 40% or less from the viewpoint of achieving good image quality.

The volume median particle size D₅₀ and the CV value of the toner particles can be measured by the method described in Examples.

### [Toner Production Method]

The toner production method according to an embodiment of the present invention may be any known method such as a melt-kneading method, an emulsion phase inversion method, a suspension polymerization method, and an emulsion aggregation method. An emulsion aggregation method and a melt-kneading method are preferable, and an emulsion aggregation method is more preferable.

### <Emulsion Aggregation Method>

The emulsion aggregation method includes a step of aggregating resin particles containing the resin A and the resin C in the same or different particles and a colorant in an aqueous medium and a step of coalescing the resin particles and the colorant.

### (Step of Aggregating Resin Particles)

In the step of aggregating the resin particles, the resin particles containing the resin A and the resin C in the same or different particles and the colorant are aggregated in an aqueous medium to produce aggregated particles 1. It is preferable that a resin particle dispersion containing resin particles and a colorant particle dispersion containing a colorant are mixed, and these particles are aggregated to produce the aggregated particles 1. Here, it is preferable to further aggregate a releasing agent in addition to the resin particles and the colorant, and it is more preferable to mix a resin particle dispersion containing resin particles, a colorant particle dispersion containing a colorant, and a releasing agent particle dispersion containing a releasing agent and to aggregate these particles to produce the aggregated particles 1. The resin particle dispersion, the colorant particle dispersion, and the releasing agent particle dispersion are more preferably an aqueous dispersion of resin particles, an aqueous dispersion of colorant particles, and an aqueous dispersion of releasing agent particles, respectively.

In the present invention, the aqueous medium used in the aqueous dispersion is a medium containing water as a main component, and the content of water in the aqueous medium is preferably 70 mass % or more, more preferably 80 mass % or more, still more preferably 90 mass % or more, and 100 mass % or less. The water is preferably deionized water or distilled water.

Examples of the component other than water that can form the aqueous medium together with water include organic solvents that dissolve in water, for example, alkyl alcohols having 1 or more and 5 or less carbons; dialkyl ketones having 3 or more and 5 or less carbons, such as acetone and methyl ethyl ketone; and cyclic ethers such as tetrahydrofuran. Among these, an alkyl alcohol having 1 or more and 5 or less carbons is preferable, and ethanol is more preferable.

### <<Method for Producing Resin Particle Dispersion>>

The resin particles of the resin A and the resin particles of the resin C may be produced in the form of an aqueous dispersion of resin particles containing the resin A and the resin C in the same or different particles.

Dispersion can be performed using a known method, and it is preferable to disperse the resin particles by using a phase inversion emulsification method. Examples of the phase inversion emulsification method include a method of adding an aqueous medium to an organic solvent solution of the resin A and/or the resin C or molten resin A and/or molten resin C to perform phase inversion emulsification. A method of adding an aqueous medium to an organic solvent solution of the resin A and/or the resin C to perform phase inversion emulsification is preferable.

The organic solvent used for the phase inversion emulsification is not particularly limited as long as it dissolves the resin A and the resin C and is water-soluble. Examples of the organic solvent include methyl ethyl ketone.

A neutralizing agent may be added to the organic solvent solution. Examples of the neutralizing agent include basic substances. Examples of the basic substance include alkali metal hydroxides such as sodium hydroxide and potassium hydroxide; and nitrogen-containing basic substances such as ammonia, trimethylamine, and diethanolamine. Among these, alkali metal hydroxides such as sodium hydroxide and potassium hydroxide are preferable.

The degree of neutralization of the resin A and/or the resin C constituting the resin particles is preferably 40 mol % or more, more preferably 50 mol % or more, still more preferably 60 mol % or more, and still more preferably 70 mol % or more, and is preferably 100 mol % or less, more preferably 95 mol % or less, and still more preferably 90 mol % or less.

The degree of neutralization of the resin A and/or the resin C constituting the resin particles can be determined using the following formula.

$$Degree of neutralization ( mol \% ) = [ \{ mass of neutralizing agent added ( g ) / equivalent of neutralizing agent \} / [ \{ weighted average acid value ( mgKOH / g ) of resin constituting resin particles \times mass ( g ) of resin constituting resin particles \} / ( 56 \times 1000 ) ] ] \times 100$$

While the organic solvent solution or molten resin A and/or resin C is stirred, an aqueous medium is gradually added to the solution or the molten resin to cause phase inversion.

The temperature of the organic solvent solution when the aqueous medium is added is preferably equal to or higher than the glass transition temperature of the resin A, more preferably 60° C. or higher, still more preferably 70° C. or higher, and is preferably 100° C. or lower, more preferably 95° C. or lower, still more preferably 90° C. or lower, from the viewpoint of improving the dispersion stability of the resin particles containing the resin A and/or the resin C.

After the phase inversion emulsification, the organic solvent may be removed from the resultant dispersion through distillation or the like as necessary. The resin particles may be isolated through filtration or the like. It is preferable to use an aqueous dispersion of resin particles obtained by removing the organic solvent from the dispersion produced after the phase inversion emulsification. In this case, the residual amount of the organic solvent in the dispersion is preferably 1 mass % or less, more preferably 0.5 mass % or less, and still more preferably substantially 0 mass %.

The volume median particle size D₅₀ of the resin particles in the dispersion is preferably 0.08 μm or more, more preferably 0.12 μm or more, and is preferably 1 μm or less, more preferably 0.5 μm or less, still more preferably 0.3 μm or less.

The CV value of the resin particles in the dispersion is preferably 10% or more, more preferably 20% or more, and preferably 40% or less, more preferably 35% or less.

The volume median particle size D₅₀ and the CV value of the resin particles in the dispersion are measured by the method described in Examples.

The solid content concentration of the aqueous dispersion of the resin particles is preferably 5 mass % or more, more preferably 10 mass % or more, and still more preferably 15 mass % or more, and is preferably 50 mass % or less, more preferably 40 mass % or less, still more preferably 35 mass % or less, from the viewpoint of improving the productivity of the toner and improving the dispersion stability of the aqueous dispersion of the resin particles.

The solid content is the total amount of nonvolatile components.

### <<Method for Producing Colorant Particle Dispersion>>

The colorant particle dispersion is preferably produced by dispersing a pigment and an aqueous medium using a disperser such as a homomixer, a homogenizer, or an ultrasonic disperser. The dispersion is preferably performed in the presence of a polymer-type pigment dispersant (preferably addition polymer E) or a surfactant from the viewpoint of improving the dispersion stability of the pigment.

The addition polymer E is an addition polymer of raw material monomers containing a styrene-based compound a from the viewpoint of the chargeability of the toner and the image density of the printed matter. That is, the addition polymer E contains a constituent unit derived from the styrene-based compound a in the main chain, from the viewpoint of the image density of the printed matter.

The raw material monomers of the addition polymer E preferably contain an addition polymerizable monomer b having an ionic group (hereinafter, also simply referred to as “monomer b”) in addition to the styrene-based compound a.

Examples of the styrene-based compound a include substituted or unsubstituted styrene. Examples of the substituent with which styrene is substituted include an alkyl group having 1 or more and 5 or less carbons, a halogen atom, an alkoxy group having 1 or more and 5 or less carbons, a sulfo group, or salts thereof.

The molecular weight of the styrene-based compound a is preferably less than 1,000, more preferably 800 or less, and still more preferably 500 or less.

Examples of the styrene-based compound a include styrene, methylstyrene, α-methylstyrene, β-methylstyrene, tert-butylstyrene, chlorostyrene, chloromethylstyrene, methoxystyrene, styrenesulfonic acid, or salts thereof. Among these, styrene and α-methylstyrene are preferable.

A single type of the styrene-based compound a may be used alone or two or more types thereof may be used in combination.

The amount of the styrene-based compound a in the raw material monomers of the addition polymer E is preferably 30 mass % or more, more preferably 50 mass % or more, and still more preferably 60 mass % or more, and is 100 mass % or less, preferably 95 mass % or less, more preferably 90 mass % or less, still more preferably 85 mass % or less, and still more preferably 75 mass % or less, from the viewpoint of the image density of the printed matter.

The ionic group in the monomer b means a group that ionically dissociates in water.

Examples of the ionic group include a carboxy group, a sulfo group, a phosphate group, an amino group, or salts thereof.

The ionic group is preferably an anionic group from the viewpoint of improving the dispersion stability of the colorant particles. The anionic group is preferably an acidic group or a salt thereof, more preferably a carboxy group, a sulfo group, or a salt thereof, and still more preferably a carboxy group or a salt thereof.

Examples of the addition polymerizable monomer having a carboxy group include (meth)acrylic acid, itaconic acid, maleic acid, fumaric acid, and 2-methacryloyloxymethylsuccinic acid.

Among these, an addition polymerizable monomer having an anionic group is preferable, (meth)acrylic acid is more preferable, and acrylic acid is still more preferable.

When the monomer b is contained, the amount of the monomer b in the raw material monomers of the addition polymer E is preferably 5 mass % or more, more preferably 10 mass % or more, still more preferably 15 mass % or more, and still more preferably 25 mass % or more, and is preferably 50 mass % or less, more preferably 40 mass % or less.

In the present invention, the pigment dispersant is preferably a copolymer of the styrene-based compound a and (meth)acrylic acid (styrene acrylic polymer).

Further, the raw material monomer of the addition polymer E may contain an addition polymerizable monomer other than the monomers a and b (additional monomer).

Examples of the additional monomer include addition polymerizable monomers having a polyalkylene oxide group such as polyalkylene glycol (meth)acrylate and methoxypolyethylene glycol (meth)acrylate, styrene-based macromonomers having an addition polymerizable functional group at one terminal, alkyl (meth)acrylates having an alkyl group having 1 or more and 22 or less (preferably 6 or more and 18 or less) carbons, and aromatic group-containing (meth)acrylates. Examples of the aromatic group-containing (meth)acrylate include benzyl (meth)acrylate and phenoxyethyl (meth)acrylate.

When such an additional monomer is contained, the amount of the additional monomer in the raw material monomers of the addition polymer E is preferably 40 mass % or less, more preferably 30 mass % or less, still more preferably 20 mass % or less, still more preferably 10 mass % or less, and still more preferably 5 mass % or less.

The weight average molecular weight of the addition polymer E is preferably 3,000 or more, more preferably 5,000 or more, still more preferably 10,000 or more, and is preferably 100,000 or less, more preferably 50,000 or less, and still more preferably 30,000 or less from the viewpoint of further improving the image density. The weight average molecular weight can be measured by the method described in Examples.

The addition polymer E can be produced by, for example, copolymerizing raw material monomers using a known polymerization method. The polymerization method is preferably a solution polymerization method in which the raw material monomers are heated in a solvent together with a polymerization initiator, a polymerization chain transfer agent, or the like to cause polymerization.

Examples of the polymerization initiator include peroxides such as dibutyl peroxide, persulfates such as sodium persulfate, and azo compounds such as 2,2′-azobis(2,4-dimethylvaleronitrile).

The addition amount of the polymerization initiator is preferably 0.5 parts by mass or more and preferably 10 parts by mass or less relative to 100 parts by mass of the raw material monomers.

Examples of the polymerization chain transfer agent include mercaptans such as 2-mercaptoethanol and 3-mercaptopropionic acid.

The addition amount of the polymerization chain transfer agent is preferably 0.01 parts by mass or more, and preferably 3 parts by mass or less relative to 100 parts by mass of the raw material monomers.

After completion of the polymerization reaction, the produced polymer may be isolated and purified from the reaction solution by a known method such as reprecipitation or solvent distillation.

The mass ratio of the colorant to the addition polymer E (colorant/addition polymer E) in the colorant particle dispersion is preferably 50/50 or more, more preferably 55/45 or more, still more preferably 60/40 or more, and is preferably 95/5 or less, more preferably 90/10 or less, still more preferably 85/15 or less, from the viewpoint of the chargeability of the toner and the image density of the printed matter.

Examples of the surfactant that improves the dispersion stability of the pigment include a nonionic surfactant, an anionic surfactant, and a cationic surfactant. From the viewpoint of improving the dispersion stability of the pigment, a nonionic surfactant is preferable. Examples of the nonionic surfactant include polyoxyalkylene alkyl ethers, polyoxyalkylene alkenyl ethers, and polyoxyalkylene aryl ethers. Among these, polyoxyethylene aryl ethers are preferable, and polyoxyethylene distyrenated phenyl ethers are more preferable.

The mass ratio of the colorant to the surfactant (colorant/surfactant) in the colorant particle dispersion is preferably 50/50 or more, more preferably 55/45 or more, still more preferably 60/40 or more, still more preferably 65/35 or more, and preferably 95/5 or less, more preferably 90/10 or less, still more preferably 85/15 or less, from the viewpoint of the chargeability of the toner and the image density of the printed matter.

In the colorant particle dispersion, the amount of the pigment is preferably 5 mass % or more, more preferably 10 mass % or more, and is preferably 50 mass % or less, more preferably 40 mass % or less, still more preferably 30 mass % or less.

The solid content concentration of the colorant particle dispersion is preferably 5 mass % or more, more preferably 10 mass % or more, and still more preferably 15 mass % or more, and is preferably 50 mass % or less, more preferably 40 mass % or less, and still more preferably 30 mass % or less.

The volume median particle size D₅₀ of the colorant particles is preferably 0.05 μm or more, more preferably 0.08 μm or more, still more preferably 0.1 μm or more, and is preferably 0.4 μm or less, more preferably 0.3 μm or less, still more preferably 0.2 μm or less, from the viewpoint of improving the dispersibility in the toner particles.

The CV value of the colorant particles is preferably 10% or more, more preferably 20% or more, and is preferably 45% or less, more preferably 40% or less, still more preferably 35% or less, from the viewpoint of improving the dispersibility in the toner particles.

The volume median particle size D₅₀ and the CV value of the colorant particles are measured by the methods described in Examples.

### <<Method for Producing Releasing Agent Particle Dispersion>>

The releasing agent particle dispersion is produced by, for example, dispersing a releasing agent, the resin particle dispersion, and an aqueous medium as necessary at a temperature equal to or higher than the melting point of the releasing agent using a disperser such as a homogenizer, a high-pressure disperser, or an ultrasonic disperser.

The heating temperature at the time of dispersion is preferably equal to or higher than the melting point of the releasing agent and 80° C. or higher, more preferably 85° C. or higher, still more preferably 90° C. or higher, and is preferably 100° C. or lower, more preferably 98° C. or lower, and still more preferably 96° C. or lower.

The releasing agent particle dispersion can be produced using a surfactant, but is preferably produced by mixing a releasing agent and the resin particles. When the releasing agent particles are prepared using the releasing agent and the resin particles, the releasing agent particles can be stabilized with the resin particles, and the releasing agent can be dispersed in the aqueous medium without using a surfactant. It is considered that the releasing agent particle dispersion has a structure in which a large number of resin particles are attached to the surfaces of the releasing agent particles.

The resin constituting the resin particles in which the releasing agent is to be dispersed is preferably a polyester-based resin. It is more preferable to use the amorphous polyester resin A described above.

The volume median particle size D₅₀ of the releasing agent particles in the releasing agent particle dispersion is preferably 0.05 μm or more, more preferably 0.1 μm or more, still more preferably 0.15 μm or more, and is preferably 1 μm or less, more preferably 0.8 μm or less, still more preferably 0.5 μm or less, from the viewpoint of obtaining uniform aggregated particles through aggregation.

The CV value of the releasing agent particles in the releasing agent particle dispersion is preferably 10% or more, more preferably 20% or more, and is preferably 50% or less.

The volume median particle size D₅₀ and the CV value of the releasing agent particles in the releasing agent particle dispersion are measured by the methods described in Examples.

### —Surfactant—

In the step of aggregating the resin particles, the dispersions of respective particles may be mixed to prepare a mixed dispersion in the presence of a surfactant, from the viewpoint of improving the dispersion stability of the resin particles, the releasing agent particles, the colorant particles, and the like. Examples of the surfactant include anionic surfactants such as alkylbenzene sulfonate and alkyl ether sulfate; and nonionic surfactants such as polyoxyethylene alkyl ethers and polyoxyethylene alkenyl ethers.

When a surfactant is used, the total amount of the surfactant to be used is preferably 0.1 parts by mass or more, more preferably 0.3 parts by mass or more, still more preferably 0.5 parts by mass or more, and is preferably 10 parts by mass or less, more preferably 5 parts by mass or less, still more preferably 3 parts by mass or less relative to 100 parts by mass of the total amount of the binder resin in the aggregated particles 1.

### —Aggregating Agent—

In the step of aggregating the resin particles, it is preferable to add an aggregating agent from the viewpoint of efficiently performing aggregation.

Examples of the aggregating agent include cationic surfactants such as quaternary salts, organic aggregating agents such as polyethyleneimine, and inorganic aggregating agents. Examples of the inorganic aggregating agent include inorganic metal salts such as sodium sulfate, sodium nitrate, sodium chloride, calcium chloride, and calcium nitrate; inorganic ammonium salts such as ammonium sulfate, ammonium chloride, and ammonium nitrate; and divalent or higher-valent metal complexes.

From the viewpoint of improving the aggregability and producing uniform aggregated particles 1, an inorganic aggregating agent having a valence of 1 or more and 5 or less is preferable, an inorganic metal salt or an inorganic ammonium salt having a valence of 1 or more and 2 or less is more preferable, an inorganic ammonium salt is still more preferable, and ammonium sulfate is still more preferable.

When an aggregating agent is used, for example, the aggregating agent is added in an amount of 25 parts by mass or more and 50 parts by mass or less relative to 100 parts by mass of the total of the binder resin in the aggregated particles 1 to a mixed dispersion containing the resin particles, the releasing agent particles, and the colorant particles at 0° C. or higher and 40° C. or lower, and the resin particles, the releasing agent particles, and the colorant particles are aggregated in the aqueous medium, to produce the aggregated particles 1. Further, it is preferable to increase the temperature of the dispersion after addition of the aggregating agent from the viewpoint of promoting aggregation.

Examples of the method for terminating aggregation include a method of cooling the dispersion, a method of adding an aggregation stopping agent, and a method of diluting the dispersion. A method of adding an aggregation stopping agent to terminate aggregation is preferable from the viewpoint of reliably preventing unnecessary aggregation.

### —Aggregation Stopping Agent—

The aggregation stopping agent is preferably a surfactant, and is more preferably an anionic surfactant. Examples of the anionic surfactant include an alkylbenzene sulfonate, an alkyl sulfate, an alkyl ether sulfate, a polyoxyalkylene alkyl ether sulfate, an aryl sulfonate, and an aryl sulfonate formalin condensate. An alkali metal salt of an aryl sulfonate formalin condensate is preferable, and a sodium salt of a β-naphthalene sulfonate formalin condensate is more preferable. One type or two or more types of these may be used. The aggregation stopping agent may be added in the form of an aqueous solution.

The addition amount of the aggregation stopping agent is preferably 10 parts by mass or more, more preferably 15 parts by mass or more relative to 100 parts by mass of the total of the binder resin in the aggregated particles 1, from the viewpoint of reliably preventing unnecessary aggregation, and is preferably 45 parts by mass or less, more preferably 40 parts by mass or less, still more preferably 35 parts by mass or less, from the viewpoint of reducing residues in the toner.

The volume median particle size D₅₀ of the aggregated particles 1 is preferably 2 μm or more, more preferably 3 μm or more, and still more preferably 4 μm or more, and is preferably 10 μm or less, more preferably 8 μm or less, and still more preferably 7 μm or less.

In the present invention, after the step of aggregating the resin particles and before the coalescing step, a step of attaching resin particles for shell containing the amorphous resin to the resultant aggregated particles 1 and aggregating the particles to produce aggregated particles 2 may be included. Toner particles having a core-shell structure can be produced by including the step of aggregating the resin particles for shell.

The resin particles for shell are preferably an amorphous resin, more preferably an amorphous polyester-based resin, and still more preferably at least one selected from the resin A and the resin B described above.

A dispersion of the resin particles for shell is produced by the same method as the above-described method for producing a resin particle dispersion containing the resin A and/or the resin C.

When the toner production method includes the step of aggregating the resin particles for shell, the aggregation is preferably terminated when the aggregated particles 2 are grown to an appropriate particle size as toner particles in the step, and a method of terminating the aggregation by adding the above-described aggregation stopping agent is preferable.

The mass ratio of the resin particles for shell to the mass of the aggregated particles 1 [resin particles for shell/aggregated particles 1] is preferably 1/99 or more, more preferably 3/97 or more, and still more preferably 5/95 or more, and is preferably 25/75 or less, more preferably 20/80 or less, and still more preferably 15/85 or less, from the viewpoint of the low-temperature fusing property of the toner.

### (Coalescing Step)

In the coalescing step, for example, the aggregated particles 1 or the aggregated particles 2 are coalesced in an aqueous medium.

Through the coalescing, the particles contained in the aggregated particles 1 or the aggregated particles 2 are coalesced together to produce coalesced particles.

In the coalescing step, the coalescing temperature is maintained at a temperature equal to or higher than the glass transition temperature of the resin having the highest glass transition temperature among the amorphous polyester-based resins contained in the aggregated particles, from the viewpoint of improving the coalescing property of the aggregated particles 1 or the aggregated particles 2 and from the viewpoint of improving the low-temperature fusing property of the toner.

From the viewpoint of improving the coalescing property of the aggregated particles and improving productivity of the toner, the holding temperature at the time of coalescing the aggregated particles is preferably not lower than a temperature higher by 2° C. than the maximum value of glass transition temperatures of the resin(s) among the amorphous polyester-based resins, more preferably not lower than a temperature higher by 3° C. than the maximum value of glass transition temperatures, and even more preferably not lower than a temperature higher by 5° C. than the maximum value of glass transition temperatures. The holding temperature at the time of coalescing the aggregated particles is also preferably not higher than a temperature higher by 30° C. than the maximum value of glass transition temperatures of the resin(s) among the amorphous polyester-based resins, more preferably not higher than a temperature higher by 25° C. than the maximum value of glass transition temperatures, and even more preferably not higher than a temperature higher by 20° C. than the maximum value of glass transition temperatures.

In this case, the time for holding the amorphous polyester-based resin at a temperature equal to or higher than the glass transition temperature is preferably 1 minute or more, more preferably 10 minutes or more, and still more preferably 30 minutes or more, and is preferably 240 minutes or less, more preferably 180 minutes or less, still more preferably 120 minutes or less, and still more preferably 90 minutes or less, from the viewpoint of improving the low-temperature fusing property of the toner.

Preferably, the temperature is held as described above until a desired circularity is achieved.

The volume median particle size D₅₀ of the coalesced particles produced through the coalescing is preferably 2 μm or more, more preferably 3 μm or more, and still more preferably 4 μm or more, and is preferably 10 μm or less, more preferably 8 μm or less, and still more preferably 7 μm or less.

The circularity of the coalesced particles produced through the coalescing is preferably 0.955 or more, and more preferably 0.960 or more, and is preferably 0.990 or less, more preferably 0.985 or less, and still more preferably 0.980 or less.

It is preferable that the coalescing is completed after the aforementioned preferable circularity is achieved.

The circularity is measured by the method described in Examples.

### (Post-Treatment Step)

A post-treatment step may be performed after the coalescing step, and toner particles are produced by isolating the coalesced particles. Since the coalesced particles produced in the coalescing step are present in an aqueous medium, it is preferable to first perform solid-liquid separation. For the solid-liquid separation, a suction filtration method or the like is preferably used.

Washing is preferably performed after the solid-liquid separation. In this case, since it is preferable to remove the added surfactant, it is preferable to perform washing with an aqueous medium at a temperature equal to or lower than the cloud point of the surfactant. The washing is preferably performed a plurality of times.

Subsequently, drying is preferably performed. Examples of the drying method include vacuum low-temperature drying, vibration type fluidized drying, spray drying, freeze-drying method, and flush jetting.

### <Melt-Kneading Method>

In the present invention, the melt-kneading method is performed, for example, by uniformly mixing the binder resin, the colorant and, as necessary, an additive such as a releasing agent with a mixer such as a Henschel mixer, and then melt-kneading the mixture with a closed kneader, a single-screw or twin-screw extruder, an open-roll kneader, or the like. Subsequently, toner particles can be produced by cooling, pulverization, and classification.

The toner contains toner particles. The produced toner particles can be used as they are as the toner of the present invention. Preferably, a toner obtained by adding an external additive to the surfaces of the toner particles is used as the toner of the present invention.

### <External Additive>

Examples of the external additive include fine particles of an inorganic material such as hydrophobic silica, titanium oxide, alumina, cerium oxide, or carbon black, and fine particles of a polymer such as polycarbonate, polymethyl methacrylate, or a silicone resin. Among these, hydrophobic silica is preferable. A single type of external additive may be used alone, or two or more types thereof may be used. Two or more types of hydrophobic silica having different particle sizes may also be used.

When the surface treatment is performed on the toner particles using an external additive, the addition amount of the external additive is preferably 1 part by mass or more, more preferably 2 parts by mass or more, and still more preferably 3 parts by mass or more, and is preferably 5 parts by mass or less, more preferably 4.5 parts by mass or less, and still more preferably 4 parts by mass or less, relative to 100 parts by mass of the toner particles.

The toner is used for electrostatic image development in electrophotographic printing. The toner can be used, for example, in the form of a one-component developer or a two-component developer mixed with a carrier.

The present invention includes the following embodiments.

<1>

A toner for electrostatic image development, containing a binder resin and a colorant, wherein
the binder resin contains an amorphous polyester resin A having an ester group concentration of 5.0 mmol/g or more and 12.0 mmol/g or less, and
the colorant is an organic yellow pigment having an NH group content of 4.0 mmol/g or more and 15.0 mmol/g or less wherein the NH group content is a value obtained by dividing a total number of —NH— and —NH₂ contained in one molecule by a molecular weight.
   <2>

The toner for electrostatic image development according to <1>, wherein the amorphous polyester resin A is a polycondensate of an alcohol component (a) and a carboxylic acid component (b), and the alcohol component (a) contains an aliphatic diol.

<3>

The toner for electrostatic image development according to <2>, wherein the alcohol component (a) contains a linear or branched aliphatic diol (a1) having 5 or 6 carbons.

<4>

The toner for electrostatic image development according to <3>, wherein the linear or branched aliphatic diol (a1) having 5 or 6 carbons is at least one selected from neopentyl glycol, 2-ethyl-2-methyl-1,3-propanediol, 2,2-dimethyl-1,4-butanediol, and 3-methyl-1,5-pentanediol.

<5>

The toner for electrostatic image development according to any of <2> to <4>, wherein the alcohol component (a) contains a linear or branched aliphatic diol (a2) having 2 or more and 4 or less carbons.

<6>

The toner for electrostatic image development according to <5>, wherein the linear or branched aliphatic diol (a2) having 2 or more and 4 or less carbons is at least one selected from ethylene glycol, 1,2-propanediol, 1,3-propanediol, 1,2-butanediol, 1,3-butanediol, 1,4-butanediol, 2,3-butanediol, and 2-methyl-1,3-propanediol.

<7>

The toner for electrostatic image development according to <5> or <6>, wherein a content of the aliphatic diol (a2) in the alcohol component (a) is 60 mol % or less, preferably 50 mol % or less.

<8>

The toner for electrostatic image development according to any of <3> to <7>, wherein a content of the aliphatic diol (a1) in the alcohol component (a) is 30 mol % or more, preferably 40 mol % or more, more preferably 50 mol % or more, and is 100 mol % or less.

<9>

The toner for electrostatic image development according to any of <2> to <8>, wherein the carboxylic acid component (b) contains an aromatic dicarboxylic acid.

<10>

The toner for electrostatic image development according to <9>, wherein the aromatic dicarboxylic acid contains at least one selected from terephthalic acid and isophthalic acid.

<11>

The toner for electrostatic image development according to <9> or <10>, wherein a content of the aromatic dicarboxylic acid in the carboxylic acid component (b) is 60 mol % or more, preferably 70 mol % or more, more preferably 80 mol % or more, and is 100 mol % or less.

<12>

The toner for electrostatic image development according to any of <1> to <11>, wherein the ester group concentration of the amorphous polyester resin A is 5.5 mmol/g or more, preferably 6.0 mmol/g or more, and is 10.0 mmol/g or less.

<13>

The toner for electrostatic image development according to any of <1> to <12>, wherein the binder resin contains a crystalline polyester resin C.

<14>

The toner for electrostatic image development according to <13>, wherein the crystalline polyester resin C is a polycondensate of an alcohol component and a carboxylic acid component, and the alcohol component contains at least one selected from ethylene glycol, 1,6-hexanediol, 1,10-decanediol, and 1,12-dodecanediol.

<15>

The toner for electrostatic image development according to <14>, wherein the alcohol component contains at least one selected from ethylene glycol and 1,10-decanediol.

<16>

The toner for electrostatic image development according to <14> or <15>, wherein the carboxylic acid component contains an aliphatic dicarboxylic acid.

<17>

The toner for electrostatic image development according to <16>, wherein the number of carbons of the aliphatic dicarboxylic acid is 4 or more, preferably 8 or more, more preferably 10 or more, and is 14 or less, preferably 12 or less.

<18>

The toner for electrostatic image development according to <16> or <17>, wherein the aliphatic dicarboxylic acid contains at least one selected from fumaric acid, sebacic acid, dodecanedioic acid, and tetradecanedioic acid.

<19>

The toner for electrostatic image development according to any of <16> to <18>, wherein a content of the aliphatic dicarboxylic acid in the carboxylic acid component is 80 mol % or more, preferably 85 mol % or more, more preferably 90 mol % or more, still more preferably 95 mol % or more, and is 100 mol % or less.

<20>

The toner for electrostatic image development according to any of <14> to <19>, wherein the carboxylic acid component contains a monocarboxylic acid, and the number of carbons of the monocarboxylic acid is 6 or more, preferably 8 or more, more preferably 12 or more, still more preferably 14 or more, still more preferably 16 or more, and is 24 or less, preferably 22 or less, more preferably 20 or less.

<21>

The toner for electrostatic image development according to <20>, wherein a content of the monocarboxylic acid in the carboxylic acid component is 1 mol % or more, preferably 5 mol % or more, more preferably 7 mol % or more, and is 35 mol % or less, preferably 30 mol % or less, more preferably 20 mol % or less, still more preferably 15 mol % or less.

<22>

The toner for electrostatic image development according to any of <13> to <21>, wherein a content of the crystalline polyester resin C in the binder resin is 3 mass % or more, preferably 5 mass % or more, more preferably 10 mass % or more, and is 50 mass % or less, preferably 30 mass % or less.

<23>

The toner for electrostatic image development according to any of <13> to <22>, wherein a mass ratio of the crystalline polyester resin C to the amorphous polyester resin A [resin C/resin A] is 0.03 or more, preferably 0.05 or more, more preferably 0.07 or more, and is 0.50 or less, preferably 0.40 or less, more preferably 0.30 or less.

<24>

The toner for electrostatic image development according to any of <1> to <23>, wherein a content of the amorphous polyester resin A in the binder resin is 50 mass % or more, preferably 70 mass % or more, and is 97 mass % or less, preferably 95 mass % or less, more preferably 90 mass % or less.

<25>

The toner for electrostatic image development according to any of <1> to <24>, wherein the NH group content of the organic yellow pigment is 5.0 mmol/g or more, preferably 7.0 mmol/g or more, and preferably 12.0 mmol/g or less.

<26>

The toner for electrostatic image development according to any of <1> to <25>, wherein the organic yellow pigment is at least one selected from a benzimidazolone pigment, an isoindoline-based pigment, and a condensed disazo-based pigment.

<27>

The toner for electrostatic image development according to any of <1> to <26>, wherein the organic yellow pigment is at least one selected from C.I. Pigment Yellow 180 and C.I. Pigment Yellow 185.

<28>

The toner for electrostatic image development according to any of <1> to <27>, wherein the toner for electrostatic image development contains toner particles, and a content of the colorant in the toner particles is 1 mass % or more, preferably 2 mass % or more, and is 20 mass % or less, preferably 15 mass % or less, more preferably 10 mass % or less.

<29>

The toner for electrostatic image development according to any of <1> to <28>, the toner containing a pigment dispersant.

<30>

The toner for electrostatic image development according to <29>, wherein the pigment dispersant is an addition polymer E.

<31>

A method for producing the toner for electrostatic image development described in any of <1> to <30>, the method including aggregating and coalescing resin particles and colorant particles, wherein
the resin particles contain an amorphous polyester resin A having an ester group concentration of 5.0 mmol/g or more and 12.0 mmol/g or less, and
the colorant is an organic yellow pigment having an NH group content of 4.0 mmol/g or more and 15.0 mmol/g or less wherein the NH group content is a value obtained by dividing a total number of —NH— and —NH₂ contained in one molecule by a molecular weight.

### EXAMPLES

Hereinafter, the present invention will be specifically described with reference to Examples, but the present invention is not limited in any way by these Examples. The respective property values were measured and evaluated by the following methods.

In the description such as “alkylene oxide (X)”, the numerical value X in parentheses means the number of moles added of alkylene oxide.

### [Measurement Method]

### [Acid Value of Resin]

The acid value of a resin was measured in accordance with the neutralization titration method described in JIS K 0070:1992. The measurement solvent was chloroform.

### [Softening Point, Crystallinity Index, Melting Point, and Glass Transition Temperature of Resin]

### (1) Softening Point

By using a flow tester “CFT-500D” (available from Shimadzu Corporation), while 1 g of a sample was heated at a temperature rising rate of 6° C./min, a load of 1.96 MPa was applied with a plunger, and the sample was extruded from a nozzle having a diameter of 1 mm and a length of 1 mm. The plunger descending amount of the flow tester was plotted against the temperature, and the temperature at which half of the sample flowed out was defined as the softening point.

### (2) Crystallinity Index

By using a differential scanning calorimeter “Q100” (available from TA Instruments Japan Inc.), 0.02 g of a sample was weighed in an aluminum pan, and cooled to 0° C. at a temperature falling rate of 10° C./min. Subsequently, the sample was allowed to stand still for 1 minute, then heated to 180° C. at a temperature rising rate of 10° C./min, and the amount of heat was measured. The crystallinity index was determined by (softening point (° C.))/(maximum endothermic peak temperature (1) (° C.)), wherein the temperature of the peak having the largest peak area among the endothermic peaks observed was defined as the maximum endothermic peak temperature (1).

### (3) Melting Point and Glass Transition Temperature

By using a differential scanning calorimeter “Q100” (available from TA Instruments Japan Inc.), 0.02 g of a sample was weighed in an aluminum pan, and the temperature was increased to 200° C., and then cooled to 0° C. at a temperature falling rate of 10° C./min. Subsequently, the sample was heated at a temperature rising rate of 10° C./min, and the amount of heat was measured. The temperature of the peak having the largest peak area among the endothermic peaks observed was defined as the maximum endothermic peak temperature (2). In the case of a crystalline resin, the peak temperature was taken as the melting point.

In the case of an amorphous resin, when a peak was observed, the temperature of the peak was defined as the glass transition temperature, whereas when a stepped portion was observed without observation of a peak, the temperature at the intersection between the tangent indicating the maximum inclination of the curve of the stepped portion and the extended line of the baseline on the low temperature side of the stepped portion was defined as the glass transition temperature.

### [Weight Average Molecular Weight of Pigment Dispersant]

An eluent was prepared by dissolving phosphoric acid and lithium bromide in N,N-dimethylformamide at concentrations of 43 mmol/L and 50 mmol/L, respectively, and the weight average molecular weight was measured by a gel permeation chromatography method [GPC device (HLC-8320GPC) available from Tosoh Corporation, columns (TSKgel SuperAWM-H, TSKgel SuperAW3000, TSKgel guardcolum SuperAW-H) available from Tosoh Corporation, flow rate: 0.5 mL/min] using, as a standard substance, a monodisperse polystyrene kit [PStQuick B (F-550, F-80, F-10, F-1, A-1000), PStQuick C (F-288, F-40, F-4, A-5000, A-500), available from Tosoh Corporation] having a known molecular weight.

The measurement sample used was prepared as follows: 0.1 g of a polymer was mixed with 10 mL of the aforementioned eluent in a glass vial, and the mixture was stirred with a magnetic stirrer at 25° C. for 10 hours, and then filtered through a syringe filter (DISMIC-13HP PTFE 0.2 μm, available from ADVANTEC).

### [Acid Value of Pigment Dispersant]

Measurement was performed in accordance with the potentiometric titration method described in JIS K 0070:1992.

### [Melting Point of Releasing Agent]

By using a differential scanning calorimeter “Q100” (available from TA Instruments Japan Inc.), 0.02 g of a sample was weighed in an aluminum pan, and the temperature was increased to 200° C., and then cooled to 0° C. at a temperature falling rate of 10° C./min. Subsequently, the sample was heated at a temperature rising rate of 10° C./min, the amount of heat was measured, and the maximum endothermic peak temperature was defined as the melting point.

### [Volume Median Particle Size D₅₀ and CV Value of Resin Particles, Releasing Agent Particles, and Colorant Particles]

(1) Measurement device: laser diffraction particle size analyzer “LA-920” (available from HORIBA, Ltd.)
(2) Measurement conditions: a sample dispersion was put in a measurement cell, distilled water was added thereto, and a volume median particle size D₅₀ and a volume average particle size D_{V} were measured at a concentration at which the absorbance was in an appropriate range. The CV value (particle size distribution) was calculated according to the following formula.

$$Solid content concentration ( mass \% ) = 100 - water content ( mass \% )$$

### [Solid Content Concentration of Resin Particle Dispersion, Colorant Particle Dispersion, and Releasing Agent Particle Dispersion]

The water content (mass %) of 5 g of the measurement sample was measured at a drying temperature of 150° C. and a measurement mode of 96 (monitoring time: 2.5 min/water content fluctuation range: 0.05%) using an infrared moisture meter “FD-230” (available from Kett Electric Laboratory Co. Ltd.). The solid content concentration was calculated according to the following formula.

$$CV value ( \% ) = ( standard deviation of particle size distribution / volume average particle size Dv ) \times 100$$

### [Volume Median Particle Size D₅₀ of Aggregated Particles

Measuring instrument: “Coulter Multisizer (registered trademark) III” (available from Beckman Coulter, Inc.)
Aperture diameter: 50 μm
Analysis software: “Multisizer (registered trademark) III version 3.51” (available from Beckman Coulter, Inc.)
Electrolytic solution: “ISOTON (registered trademark) II” (available from Beckman Coulter, Inc.)
Measurement conditions: the sample dispersion was added to 100 mL of the electrolytic solution to adjust the concentration so that the particle size of 30000 particles was able to be measured in 20 seconds. Then, 30000 particles were subjected to the measurement, and the volume median particle size D₅₀ was determined from the particle size distribution.

### [Circularity of Coalesced Particles]

Measurement device: flow-type particle image analyzer “FPIA-3000” (available from Sysmex Corporation)
Preparation of dispersion: a dispersion of coalesced particles was diluted with deionized water so as to have a solid content concentration of 0.001 to 0.05 mass %.
Measurement mode: HPF measurement mode

### [Volume Median Particle Size D₅₀ and CV Value of Toner Particles]

The measuring instrument, the aperture diameter, the analysis software, and the electrolytic solution were the same as those used in the measurement of the volume median particle size D₅₀ of the aggregated particles described above.
Dispersion: polyoxyethylene lauryl ether “EMULGEN (registered trademark) 109P” (available from Kao Corporation, HLB (Hydrophile-Lipophile Balance): 13.6) was dissolved in the electrolytic solution to prepare a dispersion having a concentration of 5 mass %.
Dispersion conditions: 10 mg of a measurement sample of toner particles was added to 5 mL of the dispersion and dispersed for 1 minute with an ultrasonic disperser, and then 25 mL of the electrolytic solution was added and further dispersed for 1 minute with the ultrasonic disperser to prepare a sample dispersion.
Measurement conditions: the sample dispersion was added to 100 mL of the electrolytic solution to adjust the concentration so that the particle size of 30000 particles was able to be measured in 20 seconds. Then, 30000 particles were subjected to the measurement, and the volume median particle size D₅₀ and the volume average particle size D_{V} were determined from the particle size distribution.

The CV value (%) was calculated according to the following formula.

$$CV value ( \% ) = ( standard deviation of particle size distribution / volume average particle size Dv ) \times 100$$

### [Production of Resin]

### [Production of Amorphous Polyester Resin A]

### Production Example A1 (Production of Resin A-1)

Neopentyl glycol, terephthalic acid, and tin(II) di(2-ethylhexanoate) shown in Table 1 were placed in a 10 L four-necked flask equipped with a thermometer, a stainless steel stirring rod, a dehydration tube, a cooling tube, and a nitrogen introduction tube, the temperature was increased to 180° C. in a mantle heater in a nitrogen atmosphere, and the reaction was performed for 2 hours. Thereafter, the temperature was increased to 210° C. at a rate of 5° C./h. After cooling to 180° C., isophthalic acid shown in Table 1 was added, the temperature was increased again to 190° C., the reaction was performed for 1 hour, and then the temperature was increased to 220° C. at a rate of 10° C./h. Thereafter, the reaction was performed at 13.3 kPa up to the softening point shown in Table 1 to produce a resin A-1. The physical property values are shown in Table 1.

### Production Example A2 (Production of Resin A-2)

The raw material monomers of a polyester resin other than isophthalic acid shown in Table 1 and tin(II) di(2-ethylhexanoate) were placed in a 10 L four-necked flask equipped with a nitrogen introduction tube, a dehydration tube, a stirrer, and a thermocouple. In a nitrogen atmosphere, the reaction system was held at 205° C. for 1 hour, then heated from 205° C. to 235° C. at 10° C./h, and then held at 235° C. for 3 hours for polycondensation. Then, after cooling to 185° C., isophthalic acid was added to the reaction system, the temperature was increased from 185° C. to 235° C. at 10° C./h, the reaction was performed at 235° C. for 5 hours, and the reaction was performed at 235° C. and 10 kPa up to the softening point shown in Table 1 to produce a resin A-2. The physical property values are shown in Table 1.

### [Production of Amorphous Polyester Resin B]

### Production Example B1 (Production of Resin B-1)

The interior of a four-necked flask equipped with a nitrogen introduction tube, a dehydration tube, a stirrer, and a thermocouple was purged with nitrogen, the raw material monomers of a polyester resin other than trimellitic anhydride shown in Table 1 and tin(II) di(2-ethylhexanoate) were added, the temperature was increased to 235° C. in a nitrogen atmosphere with stirring, and the mixture was held at 235° C. for 6 hours. Then, the pressure in the flask was further reduced, and the mixture was held at 8.3 kPa for 1 hour. Thereafter, the flask was cooled to 215° C. and returned to atmospheric pressure, then trimellitic anhydride shown in Table 1 was added, the mixture was held at 215° C. for 1 hour, then the pressure in the flask was further reduced, and the reaction was performed at 8.3 kPa up to the softening point shown in Table 1 to produce a resin B-1. The physical property values are shown in Table 1.

TABLE 1

| | | | Production Example | | | | | |
|---|---|---|---|---|---|---|---|---|
| | | | Production | | Production | | Production | |
| | | | Example A1 | | Example A2 | | Example B1 | |
| | | | Resin | | | | | |
| | | | A-1 | | A-2 | | B-1 | |
| | | | Charged | Parts by | Charged | Parts by | Charged | Parts by |
| | | | amount (g) | mol *1 | amount (g) | mol *1 | amount (g) | mol *1 |
| Raw material | Alcohol | Ethylene glycol | — | — | 973 | 40 | — | — |
| monomers of | component | Neopentyl | 3887 | 100 | 2448 | 60 | — | — |
| polyester | | glycol | | | | | | |
| resin | | BPA-PO *2 | — | — | — | — | 3880 | 70 |
| | | BPA-EO *3 | — | — | — | — | 1544 | 30 |
| | Carboxylic | Terephthalic | 3686 | 59 | 4885 | 75 | 1578 | 60 |
| | acid | acid | | | | | | |
| | component | Isophthalic acid | 2027 | 33 | 1694 | 26 | — | — |
| | | Adipic acid | — | — | — | — | 694 | 30 |
| | | Trimellitic | — | — | — | — | 304 | 10 |
| | | anhydride | | | | | | |

| | | | | |
|---|---|---|---|---|
| Esterification | Tin(II) | 19 | 50 | 40 |
| catalyst | di(2-ethylhexanoate) (g) | | | |
| Physical | Ester group concentration | 8.2 | 9.1 | 4.5 |
| properties | (mmol/g) | | | |
| | Softening point (° C.) | 105 | 10 | 114 |
| | Glass transition | 58 | 55 | 56 |
| | temperature (° C.) | | | |
| | Crystallinity index | 1.7 | 1.7 | 1.8 |
| | Acid value (mgKOH/g) | 19 | 19 | 19 |

*1: Parts by mol of each monomer relative to 100 parts by mol of the alcohol component of the raw material monomers of the polyester resin.
*2: Polyoxypropylene(2.2)-2,2-bis(4-hydroxyphenyl)propane
*3: Polyoxyethylene(2.0)-2,2-bis(4-hydroxyphenyl)propane

### [Production of Crystalline Polyester Resin C]

### Production Example C1 (Production of Resin C-1)

The raw material monomers of a polyester resin shown in Table 2 were added to a 10 L four-necked flask equipped with a nitrogen introduction tube, a dehydration tube, a stirrer, and a thermocouple, the temperature was increased to 135° C. with stirring in a nitrogen atmosphere, the mixture was held at 135° C. for 3 hours, and then the temperature was increased from 135° C. to 200° C. over 10 hours. Thereafter, tin(II) di(2-ethylhexanoate) was added, and the mixture was further held at 200° C. for 1 hour, then the pressure in the flask was reduced, and the mixture was held under a reduced pressure of 8 kPa for 1 hour to produce a resin C-1.

### Production Example C2 (Production of Resin C-2)

The interior of a 10 L four-necked flask equipped with a nitrogen introduction tube, a dehydration tube, a stirrer, and a thermocouple was purged with nitrogen, and the raw material monomers of a polyester resin shown in Table 2 were added thereto. While the reaction system was stirred, the temperature was increased to 135° C., the reaction system was held at 135° C. for 3 hours, and then the temperature was increased from 135° C. to 200° C. over 10 hours. Thereafter, 10 g of tin(II) di(2-ethylhexanoate) was added to the reaction system, and the reaction system was further held at 200° C. for 1 hour, then the pressure in the flask was reduced, and the reaction system was held under a reduced pressure of 8 kPa for 1 hour to produce a resin C-2 as a crystalline polyester resin. The physical property values are shown in Table 2.

TABLE 2

| | | | Production | | Production | |
|---|---|---|---|---|---|---|
| | | | Example C1 | | Example C2 | |
| | | | Resin | | | |
| | | | C-1 | | C-2 | |
| | | | Charged | Parts by | Charged | Parts by |
| Raw material | | | amount (g) | mol *1 | amount (g) | mol *1 |
| monomers | Alcohol | 1,10-Decanediol | 3416 | 100 | — | — |
| | component | Ethylene glycol | — | — | 1139 | 100 |
| | Carboxylic | Sebacic acid | 4084 | 103 | 3339 | 90 |
| | acid | Stearic acid | — | — | 522 | 10 |
| | component | | | | | |

| | | | |
|---|---|---|---|
| Esterification | Tin(II) | 23 | 10 |
| catalyst | di(2-ethylhexanoate) (g) | | |
| Physical | Softening point (° C.) | 88 | 78 |
| properties | Melting point (° C.) | 77 | 75 |
| | Crystallinity index | 1.1 | 1.0 |
| | Acid value (mgKOH/g) | 17 | 7 |

*1: Parts by mol of each monomer constituting the raw material monomers relative to 100 parts by mol of the alcohol component of the raw material monomers.

### Production of Pigment Dispersant (Addition Polymer F)

A monomer mixed liquid was prepared by mixing 61.6 parts by mass of acrylic acid, 128.8 parts by mass of styrene, and 9.6 parts by mass of α-methylstyrene. 20 parts by mass of methyl ethyl ketone, 0.3 parts by mass of 2-mercaptoethanol as a polymerization chain transfer agent, and 10 mass % of the monomer mixed liquid were charged into a reaction container and mixed, and the container was sufficiently purged with nitrogen gas. Meanwhile, a mixed liquid containing the remaining 90 mass of the monomer mixed liquid, 0.27 parts by mass of the polymerization chain transfer agent, 60 parts by mass of methyl ethyl ketone, and 2.2 parts by mass of an azo-based radical polymerization initiator (2,2′-azobis(2,4-dimethylvaleronitrile)) was charged into a dropping funnel, the temperature of the monomer mixed liquid in the reaction container was increased to 65° C. with stirring in a nitrogen atmosphere, and the mixed liquid in the dropping funnel was added dropwise over 3 hours. After the lapse of 2 hours at 65° C. from the completion of the dropwise addition, a solution prepared by dissolving 0.3 parts by mass of the polymerization initiator in 5 parts by mass of methyl ethyl ketone was added to the mixture, and the mixture was further aged at 65° C. for 2 hours and at 70° C. for 2 hours to produce a methyl ethyl ketone solution of addition polymer E having a carboxy group (weight average molecular weight: 20100). Thereafter, the resultant solution was dried under reduced pressure to produce an addition polymer E (acid value: 240 mgKOH/g).

### [Production of Resin Particle Dispersion]

### Production Example X1 (Production of Resin Particle Dispersion X-1)

800 g of the resin A-1, 200 g of the resin C-1, and 1000 g of methyl ethyl ketone were added to a container having an internal volume of 5 L and equipped with a stirrer, a reflux condenser, a dropping funnel, a thermometer, and a nitrogen introduction tube, and the resins were dissolved at 80° C. over 1 hour. To the resultant solution was added 5 mass % aqueous sodium hydroxide solution so that the degree of neutralization became 80 mol % with respect to the acid value of the resins, and the mixture was stirred for 30 minutes.

Subsequently, 3000 g of deionized water was added over 60 minutes with stirring at 280 r/min (peripheral velocity 88 m/min) while the temperature was maintained at 80° C., to perform phase inversion emulsification. Methyl ethyl ketone and water were distilled off under reduced pressure while the temperature was continuously maintained at 80° C. to produce an aqueous dispersion. Thereafter, the aqueous dispersion was cooled to 30° C. with stirring at 280 r/min (peripheral velocity 88 m/min), and deionized water was added so that the solid content concentration became 25 mass %, to thereby produce a resin particle dispersion X-1. The volume median particle size D₅₀ and the CV value of the resin particles in the produced resin particle dispersion X-1 are shown in Table 3.

### Production Examples X2 to X4 (Production of Resin Particle Dispersions X-2 to X-4)

Resin particle dispersions X-2 to X-4 were produced in the same manner as in Production Example X1 except that the resins to be used were changed to resins shown in Table 3. The volume median particle size D₅₀ and the CV value of the resin particles in the produced resin particle dispersions X-2 to X-4 are shown in Table 3.

### Production Example P1 (Production of Resin Particle Dispersion P-1)

200 g of the resin A-1 and 200 g of methyl ethyl ketone were added to a container having an internal volume of 3 L and equipped with a stirrer, a reflux condenser, a dropping funnel, a thermometer, and a nitrogen introduction tube, and the resin was dissolved at 80° C. over 1 hour. To the resultant solution was added 5 mass % aqueous sodium hydroxide solution so that the degree of neutralization became 75 mol % with respect to the acid value of the resin A-1, and the mixture was stirred for 30 minutes. Subsequently, 600 g of deionized water was added over 50 minutes with stirring at 280 r/min (peripheral velocity 88 m/min) while the temperature was maintained at 80° C., to perform phase inversion emulsification. Methyl ethyl ketone and water were distilled off under reduced pressure while the temperature was continuously maintained at 80° C. to produce an aqueous dispersion. Thereafter, the aqueous dispersion was cooled to 30° C. with stirring at 280 r/min (peripheral velocity 88 m/min), and deionized water was added so that the solid content concentration became 25 mass %, to thereby produce a resin particle dispersion P-1. The volume median particle size D₅₀ and the CV value of the resin particles in the produced resin particle dispersion P-1 are shown in Table 3.

TABLE 3

| Production Example | | X1 | X2 | X3 | X4 | P1 |
|---|---|---|---|---|---|---|
| Resin particle dispersion | | X-1 | X-2 | X-3 | X-4 | P-1 |
| Amorphous polyester resin A | Resin | A-1 | A-2 | A-1 | B-1 | A-1 |
| Crystalline polyester resin C | Resin | C-1 | C-1 | C-2 | C-1 | — |

| | | | | | |
|---|---|---|---|---|---|
| Volume median particle | 0.23 | 0.26 | 0.21 | 0.15 | 0.25 |
| size D₅₀ (μm) | | | | | |
| CV value (%) | 31 | 33 | 30 | 29 | 33 |

### [Production of Releasing Agent Particle Dispersion]

### Production Example W1 (Production of Releasing Agent Particle Dispersion W-1)

To a beaker having an internal volume of 1 L were added 20 g of deionized water, 100 g of the resin particle dispersion P-1, and 50 g of paraffin wax “HNP-9” (available from NIPPON SEIRO CO., LTD., melting point: 75° C.), and the mixture was melted while the temperature was maintained at 90 to 95° C. and stirred to prepare a melt mixture.

The resultant melt mixture was further subjected to a dispersion treatment for 20 minutes using an ultrasonic homogenizer “US-600T” (available from NIHONSEIKI KAISHA LTD.) while the temperature was maintained at 90 to 95° C., and then the mixture was cooled to room temperature (20° C.). Deionized water was added to the mixture so that the solid content concentration was adjusted to 40 mass %, to thereby produce a releasing agent particle dispersion W-1. The volume median particle size D₅₀ of the releasing agent particles in the releasing agent particle dispersion was 0.29 μm, and the CV value was 37%.

### Production Example W2 (Production of Releasing Agent Particle Dispersion W-2)

A releasing agent particle dispersion W-2 was produced in the same manner as in Production Example W1 except that the type of the releasing agent used was changed to Fischer-Tropsch Wax “FNP-0090” (available from NIPPON SEIRO CO., LTD., melting point: 90° C.). The volume median particle size D₅₀ of the releasing agent particles in the releasing agent particle dispersion was 0.26 μm, and the CV value was 39%.

### [Production of Colorant Particle Dispersion]

### Production Example E1 (Production of Colorant Particle Dispersion E-1)

To a container having an internal volume of 2 L were added 150 g of Toner Yellow HG (C. I. Pigment Yellow 180, available from Clariant Plastics & Coatings (Japan) K.K.), 50 g of a nonionic surfactant (polyoxyethylene distyrenated phenyl ether) “EMULGEN A-60”, and 750 g of deionized water, and the mixture was stirred at 20° C. for 1 hour at 6400 rpm/min using a stirrer “LABOLUTION” (available from PRIMIX Corporation) equipped with a dispersion blade. Thereafter, the mixture was caused to pass through a 200-mesh filter and subjected to 15 pass treatment at a pressure of 150 MPa using a homogenizer “Microfluidizer M-110 EH” (available from Microfluidics Corporation). Thereafter, the mixture was caused to pass through a 200-mesh filter, and deionized water was added thereto so that the solid content concentration became 20 mass %, to thereby produce a colorant particle dispersion E-1. The volume median particle size D₅₀ and the CV value of the colorant particles in the produced colorant particle dispersion E-1 are shown in Table 4.

### Production Examples E2 and E3 (Production of Colorant Particle Dispersions E-2 and E-3)

Colorant particle dispersions E-2 and E-3 were produced in the same manner as in Production Example E1 except that the colorant to be used was changed. The volume median particle size D₅₀ and the CV value of the colorant particles in the produced colorant particle dispersions E-2 and E-3 are shown in Table 4.

### Production Example E4 (Production of Colorant Particle Dispersion E-4)

To a container having an internal volume of 2 L were added 50 g of the addition polymer E and 108 g of methyl ethyl ketone, and the addition polymer E was dissolved at 20° C. To the resultant solution was added 30 g of 5 mol/L aqueous sodium hydroxide solution (solid content concentration: 16.9 mass %) (amount such that the degree of neutralization was 60 mol % with respect to the acid value of the addition polymer E), and 516 g of deionized water was further added, and the mixture was stirred at 20° C. for 10 minutes at 2000 r/min with a dispersion blade. Subsequently, 150 g of a yellow organic pigment, Toner Yellow HG (C. I. Pigment Yellow 180, available from Clariant Plastics & Coatings (Japan) K.K.) was added and stirred with a dispersion blade at 6400 r/min at 10° C. for 1 hour. Thereafter, the mixture was caused to pass through a 200-mesh filter and subjected to 5 pass treatment at a pressure of 150 MPa using a homogenizer “Microfluidizer M-110 EH” (available from Microfluidics Corporation). While the resultant dispersion was stirred, methyl ethyl ketone and a portion of water were removed at 70° C. under reduced pressure. After cooling, the mixture was caused to pass through a 200-mesh filter, and deionized water was added thereto so that the solid content concentration became 20 mass %, to thereby produce a colorant particle dispersion E-4. The volume median particle size D₅₀ and the CV value of the colorant particles in the produced colorant particle dispersion E-4 are shown in Table 4.

TABLE 4

| Production Example | E1 | E2 | E3 | E4 |
|---|---|---|---|---|
| Colorant particle | E-1 | E-2 | E-3 | E-4 |
| dispersion | | | | |
| Colorant | PY180 | PY185 | PY155 | PY180 |
| NH group content (mmol/g) | 8.2 | 11.9 | 2.8 | 8.2 |
| (value obtained by | | | | |
| dividing total number | | | | |
| of NH and NH₂ in one | | | | |
| molecule of pigment by | | | | |
| molecular weight of | | | | |
| pigment) | | | | |
| Colorant dispersant | EMULGEN | EMULGEN | EMULGEN | Addition |
| | A-60 | A-60 | A-60 | polymer E |
| Colorant/pigment | 75/25 | 75/25 | 75/25 | 75/25 |
| dispersant (mass ratio) | | | | |
| Volume median particle | 0.14 | 0.15 | 0.14 | 0.13 |
| size D₅₀ (μm) | | | | |
| CV value (%) | 26 | 28 | 29 | 23 |

PY180: Organic yellow pigment “Toner Yellow HG”
(C.I. Pigment Yellow 180, available from Clariant Plastics & Coatings (Japan) K.K.)
PY185: Organic yellow pigment “Paliotol Yellow D 1155”
(C.I. Pigment Yellow 185, available from BASF Colors & Effects Japan Ltd.)
PY155: Organic yellow pigment “Toner Yellow 3GP-CT”
(C.I. Pigment Yellow 155, available from Clariant Plastics & Coatings (Japan) K.K.)

### [Production of Toner]

### Example 1 (Production of Toner 1)

450 g of the resin particle dispersion X-1, 31 g of the releasing agent particle dispersion W-1, 31 g of the releasing agent particle dispersion W-2, 61 g of the colorant particle dispersion E-1, and 93 g of deionized water were placed in a 3 L four-necked flask equipped with a dehydration tube, a stirrer, and a thermocouple, and mixed at a temperature of 25° C. Subsequently, while the resultant mixture was stirred, a solution prepared by adding 4.8 mass % aqueous potassium hydroxide solution to an aqueous solution of 42 g of ammonium sulfate in 1213 g of deionized water to adjust the pH to 8.0 was added dropwise to the mixture at 25° C. over 30 minutes. Thereafter, the temperature was increased to 55° C. over 1 hour, and the temperature was held at 55° C. until the volume median particle size D₅₀ of the aggregated particles became 6.0 μm, to thereby produce a dispersion of the aggregated particles 1.

To the produced dispersion of the aggregated particles 1 were added 208 g of 20 mass % aqueous solution of DEMOL N (sodium salt of β-naphthalenesulfonic acid formalin condensate, available from Kao Corporation), 477 g of deionized water, and 383 g of 4.8 mass % aqueous potassium hydroxide solution. Thereafter, the temperature was increased to 75° C. over 1 hour and held at 75° C. until the circularity reached 0.970, to thereby produce a dispersion of coalesced particles formed by coalescing of the aggregated particles 1.

The produced dispersion of coalesced particles was cooled to 30° C., and the dispersion was subjected to suction filtration to separate a solid content. Thereafter, the resultant product was washed with deionized water at 25° C., and subjected to suction filtration at 25° C. for 2 hours. Thereafter, vacuum drying was performed at 33° C. for 24 hours using a vacuum constant temperature dryer “DRV 622DA” (available from ADVANTEC) to produce toner particles 1.

100 parts by mass of the toner particles 1, 2.5 parts by mass of hydrophobic silica “RY50” (available from Nippon Aerosil Co., Ltd., number average particle size; 0.04 μm), and 1.0 part by mass of hydrophobic silica “CAB-O-SIL (registered trademark) TS720” (available from Cabot Japan Co., Ltd., number average particle size; 0.012 μm) were placed in a Henschel mixer and stirred, and the mixture was caused to pass through a 150-mesh sieve to produce a toner 1. The produced toner 1 was evaluated as follows. The physical property values of the toner particles 1 and the evaluation results of the toner 1 are shown in Table 5.

### [Evaluation of Toner]

### [Image Density of Printed Matter]

By using a commercially available printer “Microline 5400” (available from OKI Electric Industry Co., Ltd.), a solid image in which the toner adhesion amount on paper was 0.30 mg/cm² was output on a high quality paper “J paper A4 size” (available from FUJIFILM Business Innovation Corp.) without being fused.

Subsequently, the same printer in which the fusing device was modified to be variable in temperature was provided, the temperature of the fusing device was set to 130° C., and the toner was fused at a rate of 1.7 seconds per sheet in the A4 longitudinal direction to form a printed matter.

Thirty sheets of high-quality paper “Excellent white paper A4 size” (available from OKI Electric Industry Co., Ltd.) were placed under the printed matter, the reflection image density of the solid image portion of the output printed matter was measured using a colorimeter “SpectroEye” (available from GretagMacbeth LLC, photoradiation conditions; standard light source D50, observation field of view 2°, concentration reference DINNB, absolute white reference), and the values obtained by measurement at any 10 points on the image were averaged to determine the image density. The larger the numerical value, the more excellent the image density.

### [Charge Amount of Toner]

At a temperature of 25° C. and a relative humidity of 50%, 2.1 g of a toner and 27.9 g of a silicone ferrite carrier (available from Kanto Denka Kogyo Co., Ltd., average particle size: 40 μm) were placed in a 50 mL cylindrical polypropylene bottle (available from Nikko Hansen & Co., Ltd.) and were shaken 10 times vertically and 10 times horizontally for pre-stirring. Thereafter, mixing was performed at a rate of 90 r/min for 30 minutes using Turbula mixer “T2F” (available from Shinmaru Enterprises Corporation), and the charge amount was measured under the following conditions using “q/m-meter” (available from EPPING GmbH). The charge amount was measured within one week after the production of the toner.
Mesh size: 635 mesh (opening: 24 μm, made of stainless steel)
Soft blow: blow pressure (1000 V)
Suction time: 90 seconds

The charge amount is calculated from the following formula. The larger the absolute value of the numerical value, the more excellent the chargeability.

Charge amount (μC/g)=total electric quantity after 90 seconds (μC)/sucked toner amount (g)

### Examples 2 to 6 and Comparative Examples 1 and 2 (Production of Toners 2 to 6, 11, and 12)

Toners 2 to 6, 11, and 12 were produced in the same manner as in Example 1 except that the type of the resin particle dispersion used and the type of the colorant particle dispersion used were changed as shown in Table 5. The physical property values of the produced toner particles 2 to 6, 11, and 12 and the evaluation results of the toners 2 to 6, 11, and 12 are shown in Table 5.

TABLE 5

| | | Exam- | Exam- | Exam- | Exam- | Exam- | Exam- | Comparative | Comparative |
|---|---|---|---|---|---|---|---|---|---|
| | | ple 1 | ple 2 | ple 3 | ple 4 | ples 5 | ple 6 | Example 1 | Example 2 |
| Toner | | 1 | 2 | 3 | 4 | 5 | 6 | 11 | 12 |
| Resin particle | | X-1 | X-1 | X-2 | X-2 | X-1 | X-3 | X-1 | X-4 |
| dispersion | | | | | | | | | |
| Resin | Amorphous | A-1 | A-1 | A-2 | A-2 | A-1 | A-1 | A-1 | B-1 |
| particles | polyester | | | | | | | | |
| | resin | | | | | | | | |
| | Ester group | 8.2 | 8.2 | 9.1 | 9.1 | 8.2 | 8.2 | 8.2 | 4.5 |
| | concentration | | | | | | | | |
| | (mmol/g) | | | | | | | | |
| | Crystalline | C-1 | C-1 | C-1 | C-1 | C-1 | C-2 | C-1 | C-1 |
| | polyester | | | | | | | | |
| | resin | | | | | | | | |
| Colorant particle | | E-1 | E-2 | E-1 | E-2 | E-4 | E-1 | E-3 | E-1 |
| dispersion | | | | | | | | | |
| Colorant | Type of | PY180 | PY185 | PY180 | PY185 | PY180 | PY180 | PY155 | PY180 |
| | colorant | | | | | | | | |
| | (pigment) | | | | | | | | |
| | NH group | 8.2 | 11.9 | 8.2 | 11.9 | 8.2 | 8.2 | 2.8 | 8.2 |
| | content | | | | | | | | |
| | (mmol/g) | | | | | | | | |
| | (value obtained | | | | | | | | |
| | by dividing | | | | | | | | |
| | total number | | | | | | | | |
| | of NH and NH₂ | | | | | | | | |
| | in one molecule | | | | | | | | |
| | of pigment by | | | | | | | | |
| | molecular weight | | | | | | | | |
| | of pigment) | | | | | | | | |
| | Type of pigment | EMULGEN | EMULGEN | EMULGEN | EMULGEN | Addition | EMULGEN | EMULGEN | EMULGEN |
| | dispersant | A-60 | A-60 | A-60 | A-60 | polymer E | A-60 | A-60 | A-60 |
| | Colorant/pigment | 75/25 | 75/25 | 75/25 | 75/25 | 75/25 | 75/25 | 75/25 | 75/25 |
| | dispersant | | | | | | | | |
| | (mass ratio) | | | | | | | | |
| Physical | Volume median | 6.0 | 6.3 | 6.3 | 6.2 | 6.1 | 6.0 | 6.2 | 6.2 |
| properties | particle size | | | | | | | | |
| of toner | D₅₀ (μm) | | | | | | | | |
| particles | CV value (%) | 27 | 30 | 33 | 34 | 28 | 25 | 31 | 30 |
| Evaluation | Charge amount | −38 | −35 | −36 | −34 | −41 | −42 | −30 | −28 |
| of toner | (μC/g) | | | | | | | | |
| | Image density | 1.54 | 1.53 | 1.54 | 1.53 | 1.51 | 1.56 | 1.38 | 1.39 |
| | of printed | | | | | | | | |
| | matter Toner | | | | | | | | |
| | adhesion amount | | | | | | | | |
| | 0.30 mg/cm² | | | | | | | | |

PY180: Organic yellow pigment “Toner Yellow HG” (C.I. Pigment Yellow 180, available from Clariant Plastics & Coatings (Japan) K.K.)
PY185: Organic yellow pigment “Paliotol Yellow D 1155” (C.I. Pigment Yellow 185, available from BASF Colors & Effects Japan Ltd.)
PY155: Organic yellow pigment “Toner Yellow 3GP-CT” (C.I. Pigment Yellow 155, available from Clariant Plastics & Coatings (Japan) K.K.)

### Example 7 (Production of Toner 7)

As shown in Table 6, 80 parts by mass of the amorphous polyester resin A-1, 20 parts by mass of the crystalline polyester resin C-1, 8 parts by mass of Toner Yellow HG (C. I. Pigment Yellow 180, available from Clariant Plastics & Coatings (Japan) K.K.), 2 parts by mass of paraffin wax “HNP-9” (available from NIPPON SEIRO CO., LTD., melting point: 75° C.) as a releasing agent, and 2 parts by mass of Fischer-Tropsch wax “FNP-0090” (available from NIPPON SEIRO CO., LTD., melting point: 90° C.) were mixed with a Henschel mixer, and then melt-kneaded under the following conditions. The resultant mixture was melt-kneaded using a co-rotating twin-screw extruder having a kneading portion with a total length of 1560 mm, a screw diameter of 42 mm, and a barrel inner diameter of 43 mm at a screw rotation speed of 200 r/min and a barrel set temperature of 100° C. to produce a melt-kneaded product. The feed rate of the mixture was 20 kg/h, and the average residence time was about 18 seconds. The produced melt-kneaded product was cooled and coarsely pulverized, then pulverized with a jet mill, and classified using an airflow classifier (available from Nippon Pneumatic Mfg. Co., Ltd.) to produce a powder (toner particles 7) having a volume median particle size (D₅₀) of 6.0 μm.

100 parts by mass of the toner particles 7, 2.5 parts by mass of hydrophobic silica “RY50” (available from Nippon Aerosil Co., Ltd., number average particle size; 0.04 μm), and 1.0 part by mass of hydrophobic silica “CAB-O-SIL (registered trademark) TS720” (available from Cabot Japan Co., Ltd., number average particle size; 0.012 am) were placed in a Henschel mixer and stirred, and the mixture was caused to pass through a 150-mesh sieve to produce a toner 7. The toner 7 was evaluated in the same manner as the toner 1. The physical property values of the toner particles 7 and the evaluation results of the toner 7 are shown in Table 6.

TABLE 6

| | | Example |
|---|---|---|
| | | 7 |
| Toner | | 7 |
| Resin | A-1 | 80 |
| | | (parts by mass) |
| | C-1 | 20 |
| | | (parts by mass) |
| Colorant | PY180 | 8 |
| | | (parts by mass) |
| Releasing agent | HNP-9 | 2 |
| | | (parts by mass) |
| | FNP-0090 | 2 |
| | | (parts by mass) |
| Physical properties | Volume median particle | 6.0 |
| of toner particles | size D₅₀ (μm) | |
| | CV value (%) | 23 |
| Evaluation of toner | Charge amount (μC/g) | −34 |
| | Image density of printed | 1.48 |
| | matter Toner adhesion | |
| | amount 0.30 mg/cm² | |

PY-180: Organic yellow pigment “Toner Yellow HG”
(C.I. Pigment Yellow 180, available from Clariant Plastics & Coatings (Japan) K.K.)
HNP-9: Paraffin wax (available from NIPPON SEIRO CO., LTD.)
FNP-0090: Fischer-Tropsch Wax (available from NIPPON SEIRO CO., LTD.)

Tables 5 and 6 show that the toner of the present invention produced using an amorphous polyester resin A having an ester group concentration of 5.0 mmol/g or more and 12.0 mmol/g or less and an organic yellow pigment having an NH group content of 4.0 mmol/g or more and 15.0 mmol/g or less has excellent charge amount, and the printed matter produced using the toner has excellent image density (Examples 1 to 7).

In contrast, the toner of Comparative Example 1 produced using an amorphous polyester resin A having an ester group concentration of 5.0 mmol/g or more and 12.0 mmol/g or less and an organic yellow pigment having an NH group content falling outside the range specified by the present invention (2.8 mmol/g) had a small charge amount, and the printed matter produced using the toner had a low image density. The toner of Comparative Example 2 produced using an organic yellow pigment having an NH group content of 4.0 mmol/g or more and 15.0 mmol/g or less and an amorphous polyester resin B having an ester group concentration falling outside the range specified by the present invention (4.5 mmol/g) had a small charge amount, and the printed matter produced using the toner had a low image density.

1. A toner for electrostatic image development, comprising:
a binder resin; and
a colorant,
wherein the binder resin comprises an amorphous polyester resin A having an ester group concentration of from 5.0 mmol/g to 12.0 mmol/g, and
the colorant comprises an organic yellow pigment having an NH group content of from 4.0 mmol/g to 15.0 mmol/g wherein the NH group content is a value obtained by dividing a total number of —NH— and —NH₂ contained in one molecule by a molecular weight.

2. The toner for electrostatic image development according to claim 1, wherein the amorphous polyester resin A comprises a polycondensate of an alcohol component (a) and a carboxylic acid component (b), and
the alcohol component (a) comprises an aliphatic diol.

3. The toner for electrostatic image development according to claim 2, wherein the alcohol component (a) comprises a linear or branched aliphatic diol (a1) having 5 or 6 carbons.

4. The toner for electrostatic image development according to claim 3, wherein a content of the aliphatic diol (a1) in the alcohol component (a) is 30 mol % or more.

5. The toner for electrostatic image development according to claim 1, wherein the binder resin further comprises a crystalline polyester resin C.

6. The toner for electrostatic image development according to claim 5, wherein the crystalline polyester resin C comprises a polycondensate of an alcohol component and a carboxylic acid component, and
the alcohol component comprises at least one selected from ethylene glycol, 1,6-hexanediol, 1,10-decanediol, and 1,12-dodecanediol.

7. The toner for electrostatic image development according to claim 6, wherein the carboxylic acid component comprises a monocarboxylic acid having from 6 to 24 carbons.

8. The toner for electrostatic image development according to claim 1, wherein the organic yellow pigment comprises at least one selected from the group consisting of a benzimidazolone pigment, an isoindoline-based pigment, and a condensed disazo-based pigment.

9. The toner for electrostatic image development according to claim 1, wherein the organic yellow pigment comprises at least one selected from the group consisting of C.I. Pigment Yellow 180 and C.I. Pigment Yellow 185.

10. The toner for electrostatic image development according to claim 1, wherein the toner for electrostatic image development comprises toner particles, and
a content of the colorant in the toner particles is from 1 mass % to 20 mass %.

11. The toner for electrostatic image development according to claim 1, the toner comprising a pigment dispersant.

12. A method for producing the toner of claim 1, the method comprising:
aggregating and coalescing resin particles and colorant particles,
wherein the resin particles comprise an amorphous polyester resin A having an ester group concentration of from 5.0 mmol/g to 12.0 mmol/g, and
the colorant comprises an organic yellow pigment having an NH group content of 4.0 mmol/g to 15.0 mmol/g wherein the NH group content is a value obtained by dividing a total number of —NH— and —NH₂ contained in one molecule by a molecular weight.

13. The toner for electrostatic image development according to claim 3, wherein the linear or branched aliphatic diol (a1) having 5 or 6 carbons comprises at least one selected from the group consisting of neopentyl glycol, 2-ethyl-2-methyl-1,3-propanediol, 2,2-dimethyl-1,4-butanediol, and 3-methyl-1,5-pentanediol.

14. The toner for electrostatic image development according to claim 5, wherein the mass ratio of the crystalline polyester resin C to the amorphous polyester resin A [resin C/resin A] is from 0.03 to 0.40.

15. The toner for electrostatic image development according to claim 1, wherein a content of the amorphous polyester resin A in the binder resin is from 50 mass % to 97 mass %.

16. The toner for electrostatic image development according to claim 5, wherein a content of the crystalline polyester resin C in the binder resin is from 3 mass % to 30 mass %.

17. The toner for electrostatic image development according to claim 11, wherein the pigment dispersant comprises an addition polymer E.
